(19) United States
(12) Patent Application Publication
(10) Pub. No.: US 2020/0062898 A1
(43) Pub. Date: Feb. 27, 2020

(54) METHOD FOR PREPARING POLYOLS

(71) Applicant: Econic Technologies Ltd., Macclesfield, Cheshire (GB)

(72) Inventors: Michael Kember, Macclesfield, Cheshire (GB); Rakibul Kabir, Macclesfield, Cheshire (GB); Anthea Blackburn, Macclesfield, Cheshire (GB)

(21) Appl. No.: 16/488,874

(22) PCT Filed: Mar. 1, 2018
(86) PCT No.: PCT/EP2018/055052

§ 371 Date: Aug. 26, 2019

(30) Foreign Application Priority Data
Mar. 1, 2017 (GB) 1703323.4

(51) Int. Cl. C08G 64/34; C08G 64/02; C08G 18/44

(52) U.S. Cl. CPC C08G 64/34; C08G 18/44; C08G 64/0208

(57) ABSTRACT

The present invention relates to a method for preparing a polycarbonate ether polyol, by reacting an epoxide and carbon dioxide in the presence of a catalyst of formula (I), a double metal cyanide (DMC) catalyst and a starter compound. The catalyst of formula (I) is as follows.

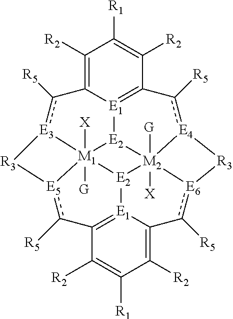

### TECHNICAL FIELD

The present invention relates to a method for preparing a polycarbonate ether polyol, by reacting an epoxide and carbon dioxide in the presence of a catalyst of formula (I), a double metal cyanide (DMC) catalyst and a starter compound.

### BACKGROUND

Polyurethanes are polymers which are prepared by reacting a di- or polyisocyanate with a polyol. Polyurethanes are used in many different products and applications, including as insulation panels, high performance adhesives, high-resilience foam seating, seals and gaskets, wheels and tyres, synthetic fibres, and the like.

The polyols used to make polyurethanes are polymers which have multiple reactive sites (e.g. multiple hydroxyl functional groups). The polyols which are most commonly used are based on polyethers or polyesters.

Polyethers are polymers having —C—O—C— linkages in their backbones. Polycarbonates are polymers having —O—C(═O)O— linkages in their backbones.

The nature and properties of the polyols have a great impact on the nature and the properties of the resultant polyurethanes. It is desirable to include polycarbonate linkages in the backbone of polyether polyols, as carbonate linkages in the polyol may improve the properties of the resultant polyurethane, for example, the presence of carbonate linkages may improve the UV stability, hydrolytic stability, chemical resistance and/or mechanical strength of the resulting polyurethane. The presence of carbonate linkages also increases the viscosity of the resulting polyol, which can limit use in some applications. It is therefore important to be able to control the ratio of ether linkages to carbonate linkages in polyols to tailor properties for widespread application. It is also important to be able to control the molecular weight and polydispersity of the polyol, as these properties impact usefulness and ease of processing of the resultant polyols.

Thus, it would be advantageous to provide a system to tune the amount of ether and carbonate linkages in order to tailor the properties of resulting polymer accordingly and to produce a range of different products for different markets.

One method for making polyether polyols in industry is by reacting an epoxide with a double metal cyanide (DMC) catalyst in the presence of a starter compound.

“DMC” catalyst is a term commonly used in documents and published patents to refer to catalysts having at least two metal centres and a cyanide ligand. Many patents related to methods for preparing the DMC catalyst and methods for preparing polyether using the DMC catalyst are disclosed [e.g. US 2008/0167502 (BASF); US 2003/0158449 (Bayer); US 2003/0069389 (Shell); US 2004/0220430 (Repsol Quimica); U.S. Pat. No. 5,536,883 (Arco); US 2005/0065383 (Dow), and U.S. Pat. No. 3,427,256 (The General Tyre and Rubber Company)].

DMC catalysts for use in the preparation of polyethers were first disclosed in U.S. Pat. No. 3,427,256 by The General Tyre and Rubber Company. It was subsequently found that carrying out this reaction in the presence of a starter compound yielded a polyether polyol.

DMC catalysts are also capable of preparing polyether polyols which contain carbonate linkages in the polymer backbone (hereinafter referred to as polycarbonate ether polyols). It should be noted that the term “polycarbonate ether” can interchangeably be used with the term “polyether carbonate”. To prepare these types of polymers, the reaction is typically carried out at high pressures of carbon dioxide. It has generally been found that, for DMC catalysts, in order to obtain appreciable incorporation of carbon dioxide, the reaction must be carried out at pressures of 40 bar or above. This is undesirable as industrial equipment for preparing polyols are typically limited to pressures of up to 10 bar. For example, in US 2013/0072602, the examples set out the polymerisation of propylene oxide in the presence of a starter compound, and an additive at 50 bar CO₂. The resulting polycarbonate ether polyols incorporate between 17.8 and 24.1 wt % CO₂. Similar results can be seen in US 2013/0190462.

In WO 2015/022290, the examples show that when the polymerisation of propylene oxide is carried out in the presence of a DMC catalyst and a starter compound in the range of 15-25 bar CO₂, the resulting polyols incorporated between 10.0 and 15.4 wt % CO₂.

It is therefore desirable to be able to prepare polycarbonate ether polyols under pressures used in industrial polyether polyol equipment. It is also desirable to obtain appreciable incorporation of carbon dioxide (e.g. ≥20 wt % carbon dioxide, which requires a proportion of carbonate linkages of ˜0.5 in the polymer backbone, depending on the nature of the starter used) under low pressures.

WO 2010/028362 discloses a method for making polycarbonate polyols by copolymerising carbon dioxide and an epoxide in the presence of a chain transfer agent and a catalyst having a permanent ligand set which complexes a single metal atom. The polyols prepared in the examples have a proportion of carbonate linkages ≥0.95 in the polymer backbone. These systems are designed to prepare polycarbonates having little or no ether linkages in the polymer backbones. Furthermore, each of the examples is carried out at high pressures of 300 psig (about 20 bar) carbon dioxide.

WO 2013/034750 discloses a method for preparing polycarbonate polyols using a catalyst of formula (I):

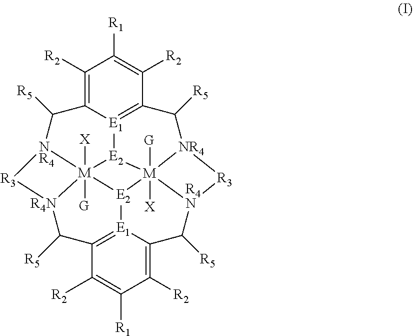

The polyols prepared in the examples have 295% carbonate linkages, and generally 299% carbonate linkages in the polymer backbone.

WO 2012/121508 relates to a process for preparing polycarbonate ethers, which are ultimately intended for use as resins and soft plastics. This document is not concerned with preparing polyols. The process disclosed in WO 2012/121508 requires the copolymerisation of an epoxide and carbon dioxide in the presence of a DMC catalyst and a metal salen catalyst having the following formula:

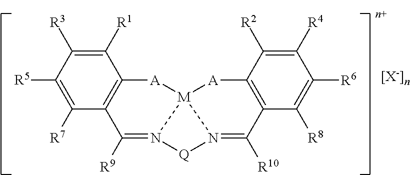

The examples are each carried out at 16 bar CO₂ or above. The resulting polycarbonate ethers contain varying amounts of ether and carbonate linkages, with 0.67 carbonate (i.e. 67%) being the highest carbonate content achieved in WO 2012/121508. However, said polymers have a high molecular weight, have high polydispersity indices (that is, PDIs of 3.8 and above) and are not terminated by hydroxyl groups. These polymers cannot therefore be used to make polyurethanes.

Gao et al, Journal of Polymer Science Part A: Polymer Chemistry, 2012, 50, 5177-5184, describes a method for preparing low molecular weight polycarbonate ether polyol using a DMC catalyst and a di-carboxylic acid starter. The proportion of carbonate linkages can be increased up to 0.75 in the resultant polyols by decreasing the temperature (50° C.) and increasing the pressure (40 bar), when using a dicarboxylic acid starter which is apparently crucial to the ability to prepare polyols with high proportions of carbonate linkages. These conditions are unfavourable for economic industrial application. Gao et al suggests that dual catalysts systems for preparing polycarbonate ether polyols are unfavourable.

PCT/GB2016/052676 discloses a method for preparing polycarbonate ether polyols, by reacting an epoxide and carbon dioxide in the presence of a starter compound, a DMC catalyst, and a catalyst of formula (I):

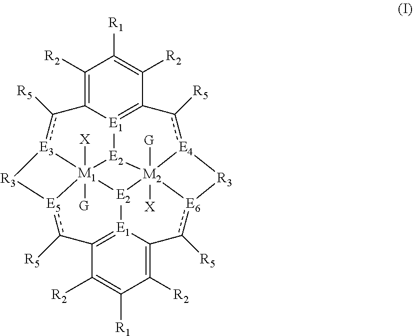

It has surprisingly been found that a specific subclass of DMC catalysts, in combination with a catalyst of formula (I) can provide advantages when preparing polycarbonate ether polyols.

### SUMMARY OF THE INVENTION

The invention relates to a method for preparing a polycarbonate ether polyol by reacting an epoxide and carbon dioxide in the presence of a catalyst of formula (I), a double metal cyanide (DMC) catalyst and a starter compound, wherein the DMC catalyst contains at least two metal centres, cyanide ligands, and a first and a second complexing agent, wherein the first complexing agents is a polymer.

The catalyst of formula (I) is as follows:

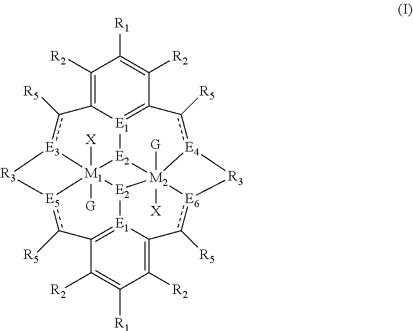

wherein:
M₁ and M₂ are independently selected from Zn(II), Cr(II), Co(II), Cu(II), Mn(II), Mg(II), Ni(II), Fe(II), Ti(II), V(II), Cr(III)-X, Co(III)-X, Mn(III)-X, Ni(III)-X, Fe(III)-X, Ca(II), Ge(II), Al(III)-X, Ti(III)-X, V(III)-X, Ge(IV)-(X)₂ or Ti(IV)-(X)₂;
R₁ and R₂ are independently selected from hydrogen, halide, a nitro group, a nitrile group, an imine, an amine, an ether group, a silyl group, a silyl ether group, a sulfoxide group, a sulfonyl group, a sulfinate group or an acetylide group or an optionally substituted alkyl, alkenyl, alkynyl, haloalkyl, aryl, heteroaryl, alkoxy, aryloxy, alkylthio, arylthio, alicyclic or heteroalicyclic group;
   R₃ is independently selected from optionally substituted alkylene, alkenylene, alkynylene, heteroalkylene, heteroalkenylene, heteroalkynylene, arylene, heteroarylene or cycloalkylene, wherein alkylene, alkenylene, alkynylene, heteroalkylene, heteroalkenylene and heteroalkynylene, may optionally be interrupted by aryl, heteroaryl, alicyclic or heteroalicyclic;
R₅ is independently selected from H, or optionally substituted aliphatic, heteroaliphatic, alicyclic, heteroalicyclic, aryl, heteroaryl, alkylheteroaryl or alkylaryl;
E₁ is C, E₂ is O, S or NH or E₁ is N and E₂ is O;
E₃, E₄, E₅ and E₆ are selected from N, NR₄, O and S, wherein when E₃, E₄, E₅ or E₆ are N, [symbol] is [symbol] and wherein when E₃, E₄, E₅ or E₆ are NR₄, O or S, [symbol] is [symbol] ;
R₄ is independently selected from H, or optionally substituted aliphatic, heteroaliphatic, alicyclic, heteroalicyclic, aryl, heteroaryl, alkylheteroaryl, -alkylC(O)OR₁₉ or -alkylC≡N or alkylaryl;
X is independently selected from OC(O)R^{x}, OSO₂R^{x}, OSOR^{x}, OSO(R^{x})₂, S(O)R^{x}, OR^{x}, phosphinate, halide, nitrate, hydroxyl, carbonate, amino, amido or optionally substituted aliphatic, heteroaliphatic, alicyclic, heteroalicyclic, aryl or heteroaryl;
Rₓ is independently hydrogen, or optionally substituted aliphatic, haloaliphatic, heteroaliphatic, alicyclic, heteroalicyclic, aryl, alkylaryl or heteroaryl; and
G is absent or independently selected from a neutral or anionic donor ligand which is a Lewis base.

The DMC catalyst comprises at least two metal centres and cyanide ligands. The DMC catalyst also additionally comprise a first and a second complexing agent (e.g. in non-stoichiometric amounts), wherein the first complexing agent is a polymer.

The second complexing agent may be selected from ethers, ketones, esters, amides, alcohols, ureas and the like. For example, the second complexing agent may be propylene glycol, (m)ethoxy ethylene glycol, dimethoxyethane, tert-butyl alcohol, ethylene glycol monomethyl ether, diglyme, triglyme, methanol, ethanol, isopropyl alcohol, n-butyl alcohol, isobutyl alcohol, sec-butyl alcohol, 3-buten-1-ol, 2-methyl-3-buten-2-ol, 2-methyl-3-butyn-2-ol, 3-methyl-1-pentyn-3-ol etc. Preferably, the second complexing agent is tert-butyl alcohol, or dimethoxymethane, more preferably, the second complexing agent is tert-butyl alcohol.

As set out above, the first complexing agent is a polymer, and is preferably a polyether, a polycarbonate ether or a polycarbonate. The first complexing agent (e.g. the polymer) is preferably present in an amount of from about 5% to about 80% by weight based on the total weight of the DMC catalyst.

It will be appreciated that the DMC catalyst may contain further complexing agents (e.g. a third complexing agent). The further complexing agent may be selected from the definitions of the first complexing agent or the second complexing agent.

The “core” of the DMC catalyst (i.e. the part of the DMC catalyst containing the at least two metal centres and the cyanide ligands) may comprise:

M′_{d}[M″ₑ(CN)_{f}]_{g}

Wherein M′ is selected from Zn(II), Ru(II), Ru(III), Fe(II), Ni(II), Mn(II), Co(II), Sn(II), Pb(II), Fe(III), Mo(IV), Mo(VI), Al(III), V(V), V(VI), Sr(II), W(IV), W(VI), Cu(II), and Cr(III), M″ is selected from Fe(II), Fe(III), Co(II), Co(II), Cr(II), Cr(III), Mn(II), Mn(III), Ir(III), Ni(II), Rh(III), Ru(II), V(IV), and V(V); and
d, e, f and g are integers, and are chosen to such that the DMC catalyst has electroneutrality.

The starter compound may be of the formula (III):

ZR^{Z})ₐ (III)

Z can be any group which can have 2 or more —R^{Z} groups attached to it. Thus, Z may be selected from optionally substituted alkylene, alkenylene, alkynylene, heteroalkylene, heteroalkenylene, heteroalkynylene, cycloalkylene, cycloalkenylene, hererocycloalkylene, heterocycloalkenylene, arylene, heteroarylene, or Z may be a combination of any of these groups, for example Z may be an alkylarylene, heteroalkylarylene, heteroalkylheteroarylene or alkylheteroarylene group.

a is an integer which is at least 2, each R^{Z} may be —OH, —NHR′, —SH, —C(O)OH, —P(O)(OR′)(OH), —PR′(O)(OH)₂ or —PR′(O)OH, and R′ may be H, or optionally substituted alkyl, heteroalkyl, aryl, heteroaryl, cycloalkyl or heterocycloalkyl.

The method can be carried out at pressure of between about 1 bar and about 60 bar, between about 1 bar and about 30 bar, between about 1 bar and about 20 bar, between about 1 bar and about 15 bar, or between about 1 bar and about 10 bar carbon dioxide. It will also be appreciated that the reaction is capable of being carried out at a pressure of about 5 bar or below.

The method can be carried out at temperatures of from about 0° C. to about 250° C., for example from about 40° C. to about 140° C., e.g. from about 50° C. to about 110° C., such as from about 60° C. to about 100° C., for example, from about 70° C. to about 100° C., e.g. from about 55° C. to about 80° C.

The invention also provides a polymerisation system for the copolymerisation of carbon dioxide and an epoxide, comprising:
a. A catalyst of formula (I) as defined herein,
b. A DMC catalyst as defined herein, and
c. A starter compound as herein.

The invention is capable of preparing polycarbonate ether polyols which have n ether linkages and m carbonate linkages, wherein n and m are integers, and wherein m/(n+m) is from greater than zero to less than 1.

The polyols prepared by the method of the invention may be used for further reactions, for example to prepare a polyurethane, for example by reacting a polyol composition comprising a polyol prepared by the method of the invention with a composition comprising a di- or polyisocyanate.

### Definitions

For the purpose of the present invention, an aliphatic group is a hydrocarbon moiety that may be straight chain (i.e. unbranched), branched or cyclic and may be completely saturated, or contain one or more units of unsaturation, but which is not aromatic. The term “unsaturated” means a moiety that has one or more double and/or triple bonds. The term “aliphatic” is therefore intended to encompass alkyl, cycloalkyl, alkenyl, cycloalkenyl, alkynyl or cycloalkenyl groups, and combinations thereof.

An aliphatic group is preferably a C₁₋₃₀ aliphatic group, that is, an aliphatic group with 1, 2, 3, 4, 5, 6, 7, 8, 9, 10, 11, 12, 13, 14, 15, 16, 17, 18, 19, 20, 21, 22, 23, 24, 25, 26, 27, 28, 29 or 30 carbon atoms. Preferably, an aliphatic group is a C₁₋₁₅ aliphatic, more preferably a C₁₋₁₂ aliphatic, more preferably a C₁₋₁₀ aliphatic, even more preferably a C₁₋₈ aliphatic, such as a C₁₋₆aliphatic group. Suitable aliphatic groups include linear or branched, alkyl, alkenyl and alkynyl groups, and mixtures thereof such as (cycloalkyl)alkyl groups, (cycloalkenyl)alkyl groups and (cycloalkyl)alkenyl groups.

The term “alkyl,” as used herein, refers to saturated, straight- or branched-chain hydrocarbon radicals derived by removal of a single hydrogen atom from an aliphatic moiety. An alkyl group is preferably a “C₁₋₂₀ alkyl group”, that is an alkyl group that is a straight or branched chain with 1 to 20 carbons. The alkyl group therefore has 1, 2, 3, 4, 5, 6, 7, 8, 9, 10, 11, 12, 13, 14, 15, 16, 17, 18, 19 or 20 carbon atoms. Preferably, an alkyl group is a C₁₋₁₅ alkyl, preferably a C₁₋₁₂ alkyl, more preferably a C₁₋₁₀ alkyl, even more preferably a C₁₋₈ alkyl, even more preferably a C₁₋₆ alkyl group. Specifically, examples of “C₁₋₂₀ alkyl group” include methyl group, ethyl group, n-propyl group, iso-propyl group, n-butyl group, iso-butyl group, sec-butyl group, tert-butyl group, sec-pentyl, iso-pentyl, n-pentyl group, neopentyl, n-hexyl group, sec-hexyl, n-heptyl group, n-octyl group, n-nonyl group, n-decyl group, n-undecyl group, n-dodecyl group, n-tridecyl group, n-tetradecyl group, n-pentadecyl group, n-hexadecyl group, n-heptadecyl group, n-octadecyl group, n-nonadecyl group, n-eicosyl group, 1,1-dimethylpropyl group, 1,2-dimethylpropyl group, 2,2-dimethylpropyl group, 1-ethylpropyl group, n-hexyl group, 1-ethyl-2-methylpropyl group, 1,1,2-trimethylpropyl group, 1-ethylbutyl group, 1-methylbutyl group, 2-methylbutyl group, 1,1-dimethylbutyl group, 1,2-dimethylbutyl group, 2,2-dimethylbutyl group, 1,3-dimethylbutyl group, 2,3-dimethylbutyl group, 2-ethylbutyl group, 2-methylpentyl group, 3-methylpentyl group and the like.

The term “alkenyl,” as used herein, denotes a group derived from the removal of a single hydrogen atom from a straight- or branched-chain aliphatic moiety having at least one carbon-carbon double bond. The term “alkynyl,” as used herein, refers to a group derived from the removal of a single hydrogen atom from a straight- or branched-chain aliphatic moiety having at least one carbon-carbon triple bond. Alkenyl and alkynyl groups are preferably “C₂₋₂₀alkenyl” and “C₂₋₂₀alkynyl”, more preferably “C₂₋₁₅ alkenyl” and “C₂₋₁₅alkynyl”, even more preferably “C₂₋₁₂ alkenyl” and “C₂₋₁₂ alkynyl”, even more preferably “C₂₋₁₀ alkenyl” and “C₂₋₁₀ alkynyl”, even more preferably “C₂₋₈ alkenyl” and “C₂₋₈ alkynyl”, most preferably “C₂₋₆ alkenyl” and “C₂₋₆ alkynyl” groups, respectively. Examples of alkenyl groups include ethenyl, propenyl, allyl, 1,3-butadienyl, butenyl, 1-methyl-2-buten-1-yl, allyl, 1,3-butadienyl and allenyl. Examples of alkynyl groups include ethynyl, 2-propynyl (propargyl) and 1-propynyl.

The terms “cycloaliphatic”, “carbocycle”, or “carbocyclic” as used herein refer to a saturated or partially unsaturated cyclic aliphatic monocyclic or polycyclic (including fused, bridging and spiro-fused) ring system which has from 3 to 20 carbon atoms, that is an alicyclic group with 3, 4, 5, 6, 7, 8, 9, 10, 11, 12, 13, 14, 15, 16, 17, 18, 19 or 20 carbon atoms. Preferably, an alicyclic group has from 3 to 15, more preferably from 3 to 12, even more preferably from 3 to 10, even more preferably from 3 to 8 carbon atoms, even more preferably from 3 to 6 carbons atoms. The terms “cycloaliphatic”, “carbocycle” or “carbocyclic” also include aliphatic rings that are fused to one or more aromatic or nonaromatic rings, such as tetrahydronaphthyl rings, where the point of attachment is on the aliphatic ring. A carbocyclic group may be polycyclic, e.g. bicyclic or tricyclic. It will be appreciated that the alicyclic group may comprise an alicyclic ring bearing one or more linking or non-linking alkyl substituents, such as —CH₂-cyclohexyl. Specifically, examples of carbocycles include cyclopropane, cyclobutane, cyclopentane, cyclohexane, bicycle[2,2,1]heptane, norborene, phenyl, cyclohexene, naphthalene, spiro[4.5]decane, cycloheptane, adamantane and cyclooctane.

A heteroaliphatic group (including heteroalkyl, heteroalkenyl and heteroalkynyl) is an aliphatic group as described above, which additionally contains one or more heteroatoms. Heteroaliphatic groups therefore preferably contain from 2 to 21 atoms, preferably from 2 to 16 atoms, more preferably from 2 to 13 atoms, more preferably from 2 to 11 atoms, more preferably from 2 to 9 atoms, even more preferably from 2 to 7 atoms, wherein at least one atom is a carbon atom. Particularly preferred heteroatoms are selected from O, S, N, P and Si. When heteroaliphatic groups have two or more heteroatoms, the heteroatoms may be the same or different. Heteroaliphatic groups may be substituted or unsubstituted, branched or unbranched, cyclic or acyclic, and include saturated, unsaturated or partially unsaturated groups.

An alicyclic group is a saturated or partially unsaturated cyclic aliphatic monocyclic or polycyclic (including fused, bridging and spiro-fused) ring system which has from 3 to 20 carbon atoms, that is an alicyclic group with 3, 4, 5, 6, 7, 8, 9, 10, 11, 12, 13, 14, 15, 16, 17, 18, 19 or 20 carbon atoms. Preferably, an alicyclic group has from 3 to 15, more preferably from 3 to 12, even more preferably from 3 to 10, even more preferably from 3 to 8 carbon atoms, even more preferably from 3 to 6 carbons atoms. The term “alicyclic” encompasses cycloalkyl, cycloalkenyl and cycloalkynyl groups. It will be appreciated that the alicyclic group may comprise an alicyclic ring bearing one or more linking or non-linking alkyl substituents, such as —CH₂-cyclohexyl. Specifically, examples of the C₃₋₂₀ cycloalkyl group include cyclopropyl, cyclobutyl, cyclopentyl, cyclohexyl, cycloheptyl, adamantyl and cyclooctyl.

A heteroalicyclic group is an alicyclic group as defined above which has, in addition to carbon atoms, one or more ring heteroatoms, which are preferably selected from O, S, N, P and Si. Heteroalicyclic groups preferably contain from one to four heteroatoms, which may be the same or different. Heteroalicyclic groups preferably contain from 5 to 20 atoms, more preferably from 5 to 14 atoms, even more preferably from 5 to 12 atoms.

An aryl group or aryl ring is a monocyclic or polycyclic ring system having from 5 to 20 carbon atoms, wherein at least one ring in the system is aromatic and wherein each ring in the system contains three to twelve ring members. The term “aryl” can be used alone or as part of a larger moiety as in “aralkyl”, “aralkoxy”, or “aryloxyalkyl”. An aryl group is preferably a “C₆₋₁₂ aryl group” and is an aryl group constituted by 6, 7, 8, 9, 10, 11 or 12 carbon atoms and includes condensed ring groups such as monocyclic ring group, or bicyclic ring group and the like. Specifically, examples of “C₆₋₁₀ aryl group” include phenyl group, biphenyl group, indenyl group, anthracyl group, naphthyl group or azulenyl group and the like. It should be noted that condensed rings such as indan benzofuran, phthalimide, phenanthridine and tetrahydro naphthalene are also included in the aryl group.

The term “heteroaryl” used alone or as part of another term (such as “heteroaralkyl”, or “heteroaralkoxy”) refers to groups having 5 to 14 ring atoms, preferably 5, 6, or 9 ring atoms; having 6, 10, or 14 Π electrons shared in a cyclic array; and having, in addition to carbon atoms, from one to five heteroatoms. The term “heteroatom” refers to nitrogen, oxygen, or sulfur, and includes any oxidized form of nitrogen or sulfur, and any quaternized form of nitrogen. The term “heteroaryl” also includes groups in which a heteroaryl ring is fused to one or more aryl, cycloaliphatic, or heterocyclyl rings, where the radical or point of attachment is on the heteroaromatic ring. Examples include indolyl, isoindolyl, benzothienyl, benzofuranyl, dibenzofuranyl, indazolyl, benzimidazolyl, benzthiazolyl, quinolyl, isoquinolyl, cinnolinyl, phthalazinyl, quinazolinyl, quinoxalinyl, 4H-quinolizinyl, carbazolyl, acridinyl, phenazinyl, phenothiazinyl, phenoxazinyl, tetrahydroquinolinyl, tetrahydroisoquinolinyl, and pyrido[2,3-b]-1,4-oxazin-3(4H)-one. Thus, a heteroaryl group may be mono- or polycyclic.

The term “heteroaralkyl” refers to an alkyl group substituted by a heteroaryl, wherein the alkyl and heteroaryl portions independently are optionally substituted.

As used herein, the terms “heterocycle”, “heterocyclyl”, “heterocyclic radical”, and “heterocyclic ring” are used interchangeably and refer to a stable 5- to 7-membered monocyclic or 7-14-membered bicyclic heterocyclic moiety that is saturated, partially unsaturated, or aromatic and having, in addition to carbon atoms, one or more, preferably one to four, heteroatoms, as defined above. When used in reference to a ring atom of a heterocycle, the term “nitrogen” includes a substituted nitrogen.

Examples of alicyclic, heteroalicyclic, aryl and heteroaryl groups include but are not limited to cyclohexyl, phenyl, acridine, benzimidazole, benzofuran, benzothiophene, benzoxazole, benzothiazole, carbazole, cinnoline, dioxin, dioxane, dioxolane, dithiane, dithiazine, dithiazole, dithiolane, furan, imidazole, imidazoline, imidazolidine, indole, indoline, indolizine, indazole, isoindole, isoquinoline, isoxazole, isothiazole, morpholine, napthyridine, oxazole, oxadiazole, oxathiazole, oxathiazolidine, oxazine, oxadiazine, phenazine, phenothiazine, phenoxazine, phthalazine, piperazine, piperidine, pteridine, purine, pyran, pyrazine, pyrazole, pyrazoline, pyrazolidine, pyridazine, pyridine, pyrimidine, pyrrole, pyrrolidine, pyrroline, quinoline, quinoxaline, quinazoline, quinolizine, tetrahydrofuran, tetrazine, tetrazole, thiophene, thiadiazine, thiadiazole, thiatriazole, thiazine, thiazole, thiomorpholine, thianaphthalene, thiopyran, triazine, triazole, and trithiane.

The term “halide”, “halo” and “halogen” are used interchangeably and, as used herein mean a fluorine atom, a chlorine atom, a bromine atom, an iodine atom and the like, preferably a fluorine atom, a bromine atom or a chlorine atom, and more preferably a fluorine atom.

A haloalkyl group is preferably a “C₁₋₂₀ haloalkyl group”, more preferably a “C₁₋₁₅ haloalkyl group”, more preferably a “C₁₋₁₂ haloalkyl group”, more preferably a “C₁₋₁₀ haloalkyl group”, even more preferably a “C₁₋₈ haloalkyl group”, even more preferably a “C₁₋₆ haloalkyl group” and is a C₁₋₂₀ alkyl, a C₁₋₁₅ alkyl, a C₁₋₁₂ alkyl, a C₁₋₁₀ alkyl, a C₁₋₈ alkyl, or a C₁₋₆ alkyl group, respectively, as described above substituted with at least one halogen atom, preferably 1, 2 or 3 halogen atom(s). The term “haloalkyl” encompasses fluorinated or chlorinated groups, including perfluorinated compounds. Specifically, examples of “C₁₋₂₀ haloalkyl group” include fluoromethyl group, difluoromethyl group, trifluoromethyl group, fluoroethyl group, difluroethyl group, trifluoroethyl group, chloromethyl group, bromomethyl group, iodomethyl group and the like.

The term “acyl” as used herein refers to a group having a formula —C(O)R where R is hydrogen or an optionally substituted aliphatic, aryl, or heterocyclic group.

An alkoxy group is preferably a “C₁₋₂₀ alkoxy group”, more preferably a “C₁₋₁₅ alkoxy group”, more preferably a “C₁₋₁₂ alkoxy group”, more preferably a “C₁₋₁₀ alkoxy group”, even more preferably a “C₁₋₈ alkoxy group”, even more preferably a “C₁₋₆ alkoxy group” and is an oxy group that is bonded to the previously defined C₁₋₂₀ alkyl, C₁₋₁₅ alkyl, C₁₋₁₂ alkyl, C₁₋₁₀ alkyl, C₁₋₈ alkyl, or C₁₋₆ alkyl group respectively. Specifically, examples of “C₁₋₂₀ alkoxy group” include methoxy group, ethoxy group, n-propoxy group, iso-propoxy group, n-butoxy group, iso-butoxy group, sec-butoxy group, tert-butoxy group, n-pentyloxy group, iso-pentyloxy group, sec-pentyloxy group, n-hexyloxy group, iso-hexyloxy group, n-hexyloxy group, n-heptyloxy group, n-octyloxy group, n-nonyloxy group, n-decyloxy group, n-undecyloxy group, n-dodecyloxy group, n-tridecyloxy group, n-tetradecyloxy group, n-pentadecyloxy group, n-hexadecyloxy group, n-heptadecyloxy group, n-octadecyloxy group, n-nonadecyloxy group, n-eicosyloxy group, 1,1-dimethylpropoxy group, 1,2-dimethylpropoxy group, 2,2-dimethylpropoxy group, 2-methylbutoxy group, 1-ethyl-2-methylpropoxy group, 1,1,2-trimethylpropoxy group, 1,1-dimethylbutoxy group, 1,2-dimethylbutoxy group, 2,2-dimethylbutoxy group, 2,3-dimethylbutoxy group, 1,3-dimethylbutoxy group, 2-ethylbutoxy group, 2-methylpentyloxy group, 3-methylpentyloxy group and the like.

An aryloxy group is preferably a “C₅₋₂₀ aryloxy group”, more preferably a “C₆₋₁₂ aryloxy group”, even more preferably a “C₆₋₁₀ aryloxy group” and is an oxy group that is bonded to the previously defined C₅₋₂₀ aryl, C₆₋₁₂ aryl, or C₆₋₁₀ aryl group respectively.

An alkylthio group is preferably a “C₁₋₂₀ alkylthio group”, more preferably a “C₁₋₁₅ alkylthio group”, more preferably a “C₁₋₁₂ alkylthio group”, more preferably a “C₁₋₁₀ alkylthio group”, even more preferably a “C₁₋₈ alkylthio group”, even more preferably a “C₁₋₆ alkylthio group” and is a thio (—S—) group that is bonded to the previously defined C₁₋₂₀ alkyl, C₁₋₁₅ alkyl, C₁₋₁₂ alkyl, C₁₋₁₀ alkyl, C₁₋₈ alkyl, or C₁₋₆ alkyl group respectively.

An arylthio group is preferably a “C₅₋₂₀ arylthio group”, more preferably a “C₆₋₁₂ arylthio group”, even more preferably a “C₆₋₁₀ arylthio group” and is a thio (—S—) group that is bonded to the previously defined C₅₋₂₀ aryl, C₆₋₁₂ aryl, or C₆₋₁₀ aryl group respectively.

An alkylaryl group is preferably a “C₆₋₁₂ aryl C₁₋₂₀ alkyl group”, more preferably a preferably a “C₆₋₁₂ aryl C₁₋₁₆ alkyl group”, even more preferably a “C₆₋₁₂ aryl C₁₋₆ alkyl group” and is an aryl group as defined above bonded at any position to an alkyl group as defined above. The point of attachment of the alkylaryl group to a molecule may be via the alkyl portion and thus, preferably, the alkylaryl group is —CH₂-Ph or —CH₂CH₂—Ph. An alkylaryl group can also be referred to as “aralkyl”.

A silyl group is preferably a group —Si(Rₛ)₃, wherein each Rₛ can be independently an aliphatic, heteroaliphatic, alicyclic, heteroalicyclic, aryl or heteroaryl group as defined above. In certain embodiments, each Rₛ is independently an unsubstituted aliphatic, alicyclic or aryl. Preferably, each Rₛ is an alkyl group selected from methyl, ethyl or propyl.

A silyl ether group is preferably a group OSi(R₆)₃ wherein each R₆ can be independently an aliphatic, heteroaliphatic, alicyclic, heteroalicyclic, aryl or heteroaryl group as defined above. In certain embodiments, each R₆ can be independently an unsubstituted aliphatic, alicyclic or aryl. Preferably, each R₆ is an optionally substituted phenyl or optionally substituted alkyl group selected from methyl, ethyl, propyl or butyl (such as n-butyl or tert-butyl (tBu)). Exemplary silyl ether groups include OSi(Me)₃, OSi(Et)₃, OSi(Ph)₃, OSi(Me)₂(tBu), OSi(tBu)₃ and OSi(Ph)₂(tBu).

A nitrile group (also referred to as a cyano group) is a group CN.

An imine group is a group —CRNR, preferably a group —CHNR₇ wherein R₇ is an aliphatic, heteroaliphatic, alicyclic, heteroalicyclic, aryl or heteroaryl group as defined above. In certain embodiments, R₇ is unsubstituted aliphatic, alicyclic or aryl. Preferably R₇ is an alkyl group selected from methyl, ethyl or propyl.

An acetylide group contains a triple bond —C≡C—R₉, preferably wherein R₉ can be hydrogen, an aliphatic, heteroaliphatic, alicyclic, heteroalicyclic, aryl or heteroaryl group as defined above. For the purposes of the invention when R₉ is alkyl, the triple bond can be present at any position along the alkyl chain. In certain embodiments, R₉ is unsubstituted aliphatic, alicyclic or aryl. Preferably R₉ is methyl, ethyl, propyl or phenyl.

An amino group is preferably —NH₂, —NHR₁₀ or —N(R₁₀)₂ wherein R₁₀ can be an aliphatic, heteroaliphatic, alicyclic, heteroalicyclic, a silyl group, aryl or heteroaryl group as defined above. It will be appreciated that when the amino group is N(R₁₀)₂, each R₁₀ group can be the same or different. In certain embodiments, each R₁₀ is independently an unsubstituted aliphatic, alicyclic, silyl or aryl. Preferably R₁₀ is methyl, ethyl, propyl, SiMe₃ or phenyl.

An amido group is preferably —NR₁₁C(O)— or —C(O)—NR₁₁— wherein R₁₁ can be hydrogen, an aliphatic, heteroaliphatic, alicyclic, heteroalicyclic, aryl or heteroaryl group as defined above. In certain embodiments, R₁₁ is unsubstituted aliphatic, alicyclic or aryl. Preferably R₁₁ is hydrogen, methyl, ethyl, propyl or phenyl. The amido group may be terminated by hydrogen, an aliphatic, heteroaliphatic, alicyclic, heteroalicyclic, aryl or heteroaryl group.

An ester group is preferably —OC(O)R₁₂— or —C(O)OR₁₂— wherein R₁₂ can be an aliphatic, heteroaliphatic, alicyclic, heteroalicyclic, aryl or heteroaryl group as defined above. In certain embodiments, R₁₂ is unsubstituted aliphatic, alicyclic or aryl. Preferably R₁₂ is methyl, ethyl, propyl or phenyl. The ester group may be terminated by an aliphatic, heteroaliphatic, alicyclic, heteroalicyclic, aryl or heteroaryl group. It will be appreciated that if R₁₂ is hydrogen, then the group defined by —OC(O)R₁₂— or —C(O)OR₁₂— will be a carboxylic acid group.

A sulfoxide is preferably —S(O)R₁₃ and a sulfonyl group is preferably —S(O)₂R₁₃ wherein R₁₃ can be an aliphatic, heteroaliphatic, alicyclic, heteroalicyclic, aryl or heteroaryl group as defined above. In certain embodiments, R₁₃ is unsubstituted aliphatic, alicyclic or aryl. Preferably R₁₃ is methyl, ethyl, propyl or phenyl.

A carboxylate group is preferably —OC(O)R₁₄, wherein R₁₄ can be hydrogen, an aliphatic, heteroaliphatic, alicyclic, heteroalicyclic, aryl or heteroaryl group as defined above. In certain embodiments, R₁₄ is unsubstituted aliphatic, alicyclic or aryl. Preferably R₁₄ is hydrogen, methyl, ethyl, propyl, butyl (for example n-butyl, isobutyl or tert-butyl), phenyl, pentafluorophenyl, pentyl, hexyl, heptyl, octyl, nonyl, decyl, undecyl, dodecyl, tridecyl, tetradecyl, pentadecyl, hexadecyl, heptadecyl, octadecyl, nonadecyl, eicosyl, trifluoromethyl or adamantyl.

An acetamide is preferably MeC(O)N(R₁₅)₂ wherein R₁₅ can be hydrogen, an aliphatic, heteroaliphatic, alicyclic, heteroalicyclic, aryl or heteroaryl group as defined above. In certain embodiments, R₁₅ is unsubstituted aliphatic, alicyclic or aryl. Preferably R₁₅ is hydrogen, methyl, ethyl, propyl or phenyl.

A phosphinate group is preferably a group —OP(O)(R₁₆)₂ or —P(O)(OR₁₆)(R₁₆) wherein each R₁₆ is independently selected from hydrogen, or an aliphatic, heteroaliphatic, alicyclic, heteroalicyclic, aryl or heteroaryl group as defined above. In certain embodiments, R₁₆ is aliphatic, alicyclic or aryl, which are optionally substituted by aliphatic, alicyclic, aryl or C₁₋₆ alkoxy. Preferably R₁₆ is optionally substituted aryl or C₁₋₂₀ alkyl, more preferably phenyl optionally substituted by C₁₋₆alkoxy (preferably methoxy) or unsubstituted C₁₋₂₀alkyl (such as hexyl, octyl, decyl, dodecyl, tetradecyl, hexadecyl, stearyl). A phosphonate group is preferably a group —P(O)(OR₁₆)₂ wherein R₁₆ is as defined above. It will be appreciated that when either or both of R₁₆ is hydrogen for the group —P(O)(OR₁₆)₂, then the group defined by —P(O)(OR₁₆)₂ will be a phosphonic acid group.

A sulfinate group is preferably —S(O)OR₁₇ or —OS(O)R₁₇ wherein R₁₇ can be hydrogen, an aliphatic, heteroaliphatic, haloaliphatic, alicyclic, heteroalicyclic, aryl or heteroaryl group as defined above. In certain embodiments, R₁₇ is unsubstituted aliphatic, alicyclic or aryl. Preferably R₁₇ is hydrogen, methyl, ethyl, propyl or phenyl. It will be appreciated that if R₁₇ is hydrogen, then the group defined by —S(O)OR₁₇ will be a sulfonic acid group.

A carbonate group is preferably —OC(O)OR₈, wherein R₁₈ can be hydrogen, an aliphatic, heteroaliphatic, alicyclic, heteroalicyclic, aryl or heteroaryl group as defined above. In certain embodiments, R₁₈ is optionally substituted aliphatic, alicyclic or aryl. Preferably R₁₈ is hydrogen, methyl, ethyl, propyl, butyl (for example n-butyl, isobutyl or tert-butyl), phenyl, pentafluorophenyl, pentyl, hexyl, heptyl, octyl, nonyl, decyl, undecyl, dodecyl, tridecyl, tetradecyl, pentadecyl, hexadecyl, heptadecyl, octadecyl, nonadecyl, eicosyl, trifluoromethyl, cyclohexyl, benzyl or adamantyl. It will be appreciated that if R₁₇ is hydrogen, then the group defined by —OC(O)OR₁₈ will be a carbonic acid group.

In an -alkylC(O)OR₁₉ or -alkylC(O)R₁₉ group, R₁₉ can be hydrogen, an aliphatic, heteroaliphatic, alicyclic, heteroalicyclic, aryl or heteroaryl group as defined above. In certain embodiments, R₁₉ is unsubstituted aliphatic, alicyclic or aryl. Preferably R₁₉ is hydrogen, methyl, ethyl, propyl, butyl (for example n-butyl, isobutyl or tert-butyl), phenyl, pentafluorophenyl, pentyl, hexyl, heptyl, octyl, nonyl, decyl, undecyl, dodecyl, tridecyl, tetradecyl, pentadecyl, hexadecyl, heptadecyl, octadecyl, nonadecyl, eicosyl, trifluoromethyl or adamantyl.

It will be appreciated that where any of the above groups are present in a Lewis base G, one or more additional R groups may be present, as appropriate, to complete the valency. For example, in the context of an amino group, an additional R group may be present to give RNHR₁₀, wherein R is hydrogen, an optionally substituted aliphatic, heteroaliphatic, alicyclic, heteroalicyclic, aryl or heteroaryl group as defined above. Preferably, R is hydrogen or aliphatic, alicyclic or aryl.

As used herein, the term “optionally substituted” means that one or more of the hydrogen atoms in the optionally substituted moiety is replaced by a suitable substituent. Unless otherwise indicated, an “optionally substituted” group may have a suitable substituent at each substitutable position of the group, and when more than one position in any given structure may be substituted with more than one substituent selected from a specified group, the substituent may be either the same or different at every position. Combinations of substituents envisioned by this invention are preferably those that result in the formation of stable compounds. The term “stable”, as used herein, refers to compounds that are chemically feasible and can exist for long enough at room temperature i.e. (16-25° C.) to allow for their detection, isolation and/or use in chemical synthesis.

Substituents may be depicted as attached to a bond that crosses a bond in a ring of the depicted molecule. This convention indicates that one or more of the substituents may be attached to the ring at any available position (usually in place of a hydrogen atom of the structure). In cases where an atom of a ring has two substitutable positions, two groups (either the same or different) may be present on that atom.

Preferred optional substituents for use in the present invention include, but are not limited to, halogen, hydroxy, nitro, carboxylate, carbonate, alkoxy, aryloxy, alkylthio, arylthio, heteroaryloxy, alkylaryl, amino, amido, imine, nitrile, silyl, silyl ether, ester, sulfoxide, sulfonyl, acetylide, phosphinate, sulfonate or optionally substituted aliphatic, heteroaliphatic, alicyclic, heteroalicyclic, aryl or heteroaryl groups (for example, optionally substituted by halogen, hydroxy, nitro, carbonate, alkoxy, aryloxy, alkylthio, arylthio, amino, imine, nitrile, silyl, sulfoxide, sulfonyl, phosphinate, sulfonate or acetylide).

It will be appreciated that although in formula (I), the groups X and G are illustrated as being associated with a single M₁ or M₂ metal centre, one or more X and G groups may form a bridge between the M₁ and M₂ metal centres.

For the purposes of the present invention, the epoxide substrate is not limited. The term epoxide therefore relates to any compound comprising an epoxide moiety (i.e. a substituted or unsubstituted oxirane compound). Substituted oxiranes include monosubstituted oxiranes, disubstituted oxiranes, trisubstituted oxiranes, and tetrasubstituted oxiranes. In certain embodiments, epoxides comprise a single oxirane moiety. In certain embodiments, epoxides comprise two or more oxirane moieties.

Examples of epoxides which may be used in the present invention include, but are not limited to, cyclohexene oxide, styrene oxide, ethylene oxide, propylene oxide, butylene oxide, substituted cyclohexene oxides (such as limonene oxide, C₁₀H₁₆O or 2-(3,4-epoxycyclohexyl)ethyltrimethoxysilane, C₁₁H₂₂O), alkylene oxides (such as ethylene oxide and substituted ethylene oxides), unsubstituted or substituted oxiranes (such as oxirane, epichlorohydrin, 2-(2-methoxyethoxy)methyl oxirane (MEMO), 2-(2-(2-methoxyethoxy)ethoxy)methyl oxirane (ME2MO), 2-(2-(2-(2-methoxyethoxy)ethoxy)ethoxy)methyl oxirane (ME3MO), 1,2-epoxybutane, glycidyl ethers, vinyl-cyclohexene oxide, 3-phenyl-1,2-epoxypropane, 1,2- and 2,3-epoxybutane, isobutylene oxide, cyclopentene oxide, 2,3-epoxy-1,2,3,4-tetrahydronaphthalene, indene oxide, and functionalized 3,5-dioxaepoxides. Examples of functionalized 3,5-dioxaepoxides include:

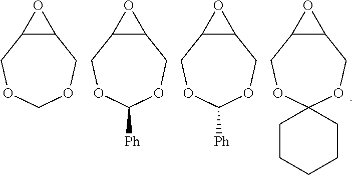

The epoxide moiety may be a glycidyl ether, glycidyl ester or glycidyl carbonate. Examples of glycidyl ethers, glycidyl esters glycidyl carbonates include:

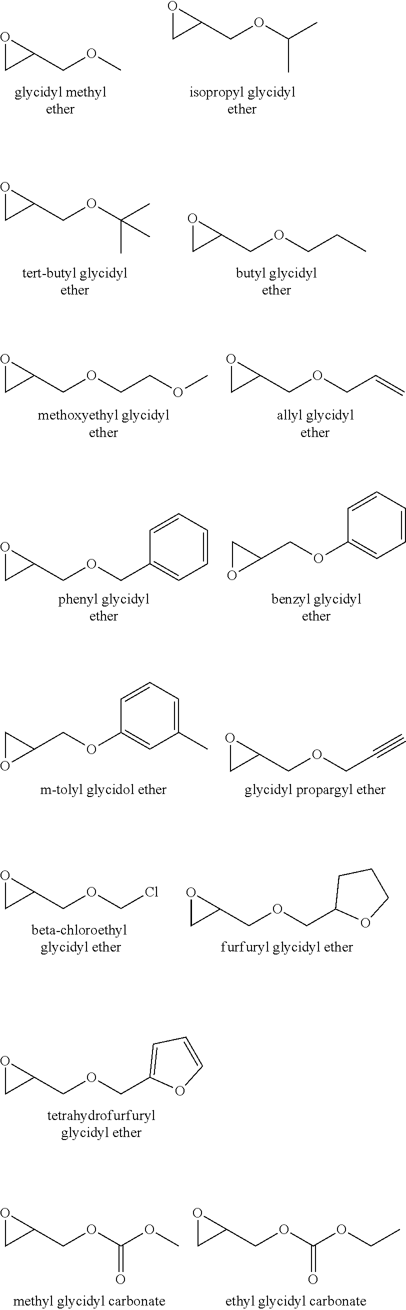

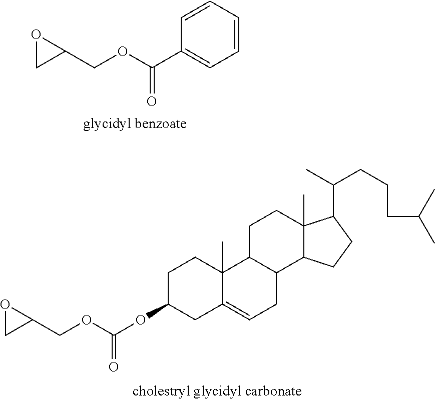 [SMILES: O=C(OCC1CO1)c1ccccc1 ; CC(C)CCCC(C)C1CCC2C3CC=C4C[C@@H](OC(=O)OCC5CO5)CCC4(C)C3CCC12C]

As noted above, the epoxide substrate may contain more than one epoxide moiety, i.e. it may be a bis-epoxide, a tris-epoxide, or a multi-epoxide containing moiety. Examples of compounds including more than one epoxide moiety include bisphenol A diglycidyl ether and 3,4-epoxycyclohexylmethyl 3,4-epoxycyclohexanecarboxylate. It will be understood that reactions carried out in the presence of one or more compounds having more than one epoxide moiety may lead to cross-linking in the resulting polymer.

The skilled person will appreciate that the epoxide can be obtained from “green” or renewable resources. The epoxide may be obtained from a (poly)unsaturated compound, such as those deriving from a fatty acid and/or terpene, obtained using standard oxidation chemistries.

The epoxide moiety may contain —OH moieties, or protected —OH moieties. The —OH moieties may be protected by any suitable protecting group. Suitable protecting groups include methyl or other alkyl groups, benzyl, allyl, tert-butyl, tetrahydropyranyl (THP), methoxymethyl (MOM), acetyl (C(O)alkyl), benzolyl (C(O)Ph), dimethoxytrityl (DMT), methoxyethoxymethyl (MEM), p-methoxybenzyl (PMB), trityl, silyl (such as trimethylsilyl (TMS), t-Butyldimethylsilyl (TBDMS), t-Butyldiphenylsilyl (TBDPS), tri-iso-propylsilyloxymethyl (TOM), and triisopropylsilyl (TIPS)), (4-methoxyphenyl)diphenylmethyl (MMT), tetrahydrofuranyl (THF), and tetrahydropyranyl (THP).

The epoxide preferably has a purity of at least 98%, more preferably >99%.

It will be understood that the term “an epoxide” is intended to encompass one or more epoxides. In other words, the term “an epoxide” refers to a single epoxide, or a mixture of two or more different epoxides. For example, the epoxide substrate may be a mixture of ethylene oxide and propylene oxide, a mixture of cyclohexene oxide and propylene oxide, a mixture of ethylene oxide and cyclohexene oxide, or a mixture of ethylene oxide, propylene oxide and cyclohexene oxide.

### DETAILED DESCRIPTION

The present invention provides a method for reacting an epoxide with carbon dioxide in the presence of a catalyst of formula (I), a double metal cyanide (DMC) catalyst, and a starter compound, wherein the DMC catalyst contains at least two metal centres, cyanide ligands, and a first and a second complexing agent, wherein the first complexing agent is a polymer.

### Catalysts of Formula (I)

The catalyst of formula (I) has the following structure:

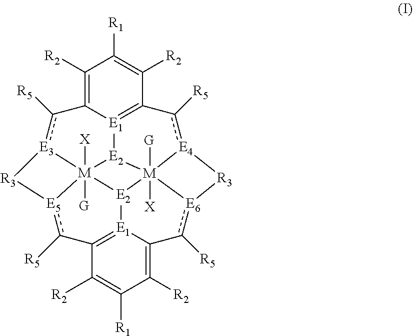

wherein:
M₁ and M₂ are independently selected from Zn(II), Cr(II), Co(II), Cu(II), Mn(II), Mg(II), Ni(II), Fe(II), Ti(II), V(II), Cr(III)-X, Co(III)-X, Mn(III)-X, Ni(III)-X, Fe(III)-X, Ca(II), Ge(II), Al(III)-X, Ti(III)-X, V(III)-X, Ge(IV)-(X)₂ or Ti(IV)-(X)₂;
R₁ and R₂ are independently selected from hydrogen, halide, a nitro group, a nitrile group, an imine, an amine, an ether group, a silyl group, a silyl ether group, a sulfoxide group, a sulfonyl group, a sulfinate group or an acetylide group or an optionally substituted alkyl, alkenyl, alkynyl, haloalkyl, aryl, heteroaryl, alkoxy, aryloxy, alkylthio, arylthio, alicyclic or heteroalicyclic group;
   R₃ is independently selected from optionally substituted alkylene, alkenylene, alkynylene, heteroalkylene, heteroalkenylene, heteroalkynylene, arylene, heteroarylene or cycloalkylene, wherein alkylene, alkenylene, alkynylene, heteroalkylene, heteroalkenylene and heteroalkynylene, may optionally be interrupted by aryl, heteroaryl, alicyclic or heteroalicyclic;
R₅ is independently selected from H, or optionally substituted aliphatic, heteroaliphatic, alicyclic, heteroalicyclic, aryl, heteroaryl, alkylheteroaryl or alkylaryl;
E₁ is C, E₂ is O, S or NH or E₁ is N and E₂ is O;
E₃, E₄, E₅ and E₆ are selected from N, NR₄, O and S, wherein when E₃, E₄, E₅ or E₆ are N, [symbol] is [symbol] and wherein when E₃, E₄, E₅ or E₆ are NR₄, O or S, [symbol] is [symbol] ; R₄ is independently selected from H, or optionally substituted aliphatic, heteroaliphatic, alicyclic, heteroalicyclic, aryl, heteroaryl, alkylheteroaryl, -alkylC(O)OR₁₉ or -alkylC≡N or alkylaryl;
X is independently selected from OC(O)R^{x}, OSO₂R^{x}, OSOR^{x}, OSO(R^{x})₂, S(O)R^{x}, OR^{x}, phosphinate, halide, nitrate, hydroxyl, carbonate, amino, amido or optionally substituted aliphatic, heteroaliphatic, alicyclic, heteroalicyclic, aryl or heteroaryl, wherein each X may be the same or different and wherein X may form a bridge between M₁ and M₂;
Rₓ is independently hydrogen, or optionally substituted aliphatic, haloaliphatic, heteroaliphatic, alicyclic, heteroalicyclic, aryl, alkylaryl or heteroaryl; and
G is absent or independently selected from a neutral or anionic donor ligand which is a Lewis base.

Each of the occurrences of the groups R₁ and R₂ may be the same or different, and R₁ and R₂ can be the same or different.

Preferably R₁ and R₂ are independently selected from hydrogen, halide, amino, nitro, sulfoxide, sulfonyl, sulfinate, and an optionally substituted alkyl, alkenyl, aryl, heteroaryl, silyl, silyl ether, alkoxy, aryloxy or alkylthio. Preferably each occurrence of R₂ is the same. Preferably, each occurrence of R₂ is the same, and is hydrogen.

Both occurrences of R₁ may be the same, and may be selected from hydrogen, halide, amino, nitro, sulfoxide, sulfonyl, sulfinate, silyl, silyl ether and an optionally substituted alkyl, alkenyl, aryl, heteroaryl, alkoxy, aryloxy or alkylthio. For example, both occurrences of R₁ may be the same, and may be selected from hydrogen, halide, sulfoxide, and an optionally substituted alkyl, heteroaryl, silyl, alkylthio or alkoxy. Exemplary options for R₁ (which may both be the same) include hydrogen, methyl, t-butyl, methoxy, ethoxy, alkylthio, trialkylsilyl such as trimethylsilyl or triethylsilyl, bromide, methanesulfonyl, or piperidinyl, e.g. both occurrences of R₁ may be the same, and may be selected from methyl, t-butyl or trialkylsilyl.

Preferably, each occurrence of R₂ is hydrogen and each R₁ is independently selected from hydrogen, halide, amino, nitro, sulfoxide, sulfonyl, sulfinate, and optionally substituted alkyl, alkenyl, aryl, heteroaryl, silyl, silyl ether, alkoxy, aryloxy, alkylthio, arylthio, such as hydrogen, C₁₋₆ alkyl (e.g. haloalkyl), alkoxy, aryl, halide, nitro, sulfonyl, silyl and alkylthio, for example, ^{t}Bu, iPr, Me, OMe, H, nitro, SO₂Me, SiEt₃, SiMe₃, SMe, halogen or phenyl.

It will be understood that each occurrence of R¹ may be the same, and each occurrence of R₂ may be the same, and R₁ may be different to R₂.

It will be appreciated that the group R₃ can be a disubstituted divalent alkyl, alkenyl, alkynyl, heteroalkyl, heteroalkenyl or heteroalkynyl group which may optionally be interrupted by an aryl, heteroaryl, alicyclic or heteroalicyclic group, or may be a disubstituted aryl or cycloalkyl group which acts as a bridging group between two nitrogen centres in the catalyst of formula (I). Thus, where R₃ is an alkylene group, such as dimethylpropylenyl, the R₃ group has the structure —CH₂—C(CH₃)₂—CH₂—. The definitions of the alkyl, aryl, cycloalkyl etc groups set out above therefore also relate respectively to the divalent alkylene, arylene, cycloalkylene etc groups set out for R3, and may be optionally substituted. Exemplary options for R3 include ethylenyl, 2,2-fluoropropylenyl, 2,2-dimethylpropylenyl, propylenyl, butylenyl, phenylenyl, cyclohexylenyl or biphenylenyl. When R3 is cyclohexylenyl, it can be the racemic, RR- or SS- forms.

R₃ can be independently selected from substituted or unsubstituted alkylene and substituted or unsubstituted arylene, preferably substituted or unsubstituted propylenyl, such as propylenyl and 2,2-dimethylpropylenyl, and substituted or unsubstituted phenylenyl or biphenylenyl. Preferably both occurrences of R₃ are the same. Even more preferably R₃ is a substituted propylenyl, such as 2,2-di(alkyl)propylenyl, especially 2,2-di(methyl)propylenyl.

R₃ can be independently selected from substituted or unsubstituted alkylene, alkenylene, alkynylene, heteroalkylene, heteroalkenylene or heteroalkynylene, arylene or cycloalkylene. Preferably, R₃ is selected from substituted or unsubstituted alkylene, cycloalkylene, alkenylene, heteroalkylene and arylene. More preferably, R₃ is selected from 2,2-dimethylpropylenyl, —CH₂CH₂CH₂—, —CH₂CH(CH₃)CH₂—, —CH₂C(CH₂C₆H₅)₂CH₂—, phenylene, —CH₂CH₂—, —CH₂ CH₂ CH₂ CH₂—, —CH₂ CH₂N (CH₃) CH₂ CH₂—, 1,4-cyclohexandiyl or —CH₂CH₂CH (C₂H₅)—. Still more preferably R₃ is selected from 2,2-dimethylpropylenyl, —CH₂ CH₂ CH₂—, —CH₂CH(CH₃)CH₂—, —CH₂C(CH₂C₆H₅)₂CH₂—, —CH₂CH₂CH (C₂H₅)—, —CH₂ CH₂ CH₂ CH₂—. More preferably still, R₃ is selected from 2,2-dimethylpropylenyl, —CH₂C(CH₂C₆H₅)₂CH₂—, CH₂CH(CH₃)CH₂ and —CH₂C(C₂H₅)₂ CH₂—.

Most preferably R₃ is a substituted propylenyl, such as 2,2-di(alkyl)propylenyl, more preferably 2,2-dimethylpropylenyl.

As set out above, E₃, E₄, E₅ and E₆ are each independently selected from N, NR₄, O and S. The skilled person will understand that if any of E₃, E₄, E₅ or E₆ are N, [symbol] is [symbol] , and if any of E₃, E₄, E₅ or E₆ are NR₄, O or S, [symbol] is [symbol] . Preferably, E₃, E₄, E₅ and E₆ are each independently selected from NR₄, O and S.

Preferably each R₄ is independently selected from hydrogen, and an optionally substituted alkyl, alkenyl, alkynyl, aryl, heteroalkyl, heteroalkenyl, heteroalkynyl, heteroaryl, -alkylC(O)OR₁₉ or -alkylC≡N. Each R₄ may be the same or different. Preferably, R₄ is selected from hydrogen, and an optionally substituted alkyl, alkenyl, alkynyl, aryl,

heteroalkyl, heteroalkenyl, heteroalkynyl or heteroaryl. Exemplary options for R₄ include H, Me, Et, Bn, iPr, tBu or Ph, and —CH₂—(pyridine). Preferably each R₄ is hydrogen or alkyl.

Preferably each R₅ is independently selected from hydrogen, and optionally substituted aliphatic or aryl. More preferably, each R₅ is independently selected from hydrogen, and optionally substituted alkyl or aryl. Even more preferably, each R₅ is the same, and is selected from hydrogen, and optionally substituted alkyl or aryl. Exemplary R₅ groups include hydrogen, methyl, ethyl, phenyl and trifluoromethyl, preferably hydrogen, methyl or trifluoromethyl. Even more preferably, each R₅ is hydrogen.

Preferably both occurrences of E₁ are C and both occurrences of E₂ are the same, and selected from O, S or NH. Even more preferably, both occurrences of E₁ are C and both occurrences of E₂ are O.

The skilled person will appreciate that the macrocyclic ligand of the catalyst of formula (I) may be symmetric, or may be asymmetric.

When the macrocyclic ligand is symmetric, it will be appreciated that each occurrence of E₃, E₄, E₅ and E₆ will be the same. For example, each occurrence of E₃, E₄, E₅ and E₆ may be NR₄ (and each R₄ may be the same). It will be understood that E₃, E₄, E₅ and E₆ may be the same and may be NH. In other words, the catalyst of formula (I) may have the following structure:

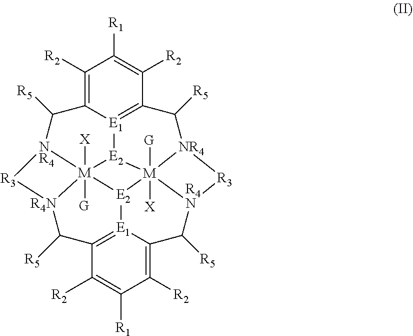

When the macrocyclic ligand is symmetric, it will be appreciated that each occurrence of R₁ may be the same, each occurrence of R₂ may be the same, each occurrence of R₃ may be the same, each occurrence of R₅ may be the same, each occurrence of E₁ may be the same, and each occurrence of E₂ may be the same (although R₁, R₂, R₃ and R₅ are not necessarily the same as each other), and E₃, E₄, E₅ and E₆ are the same.

For example, each occurrence of R₂, and R₅ may be hydrogen, each occurrence of E₃, E₄, E₅ and E₆ are NR₄, and each R₄ is hydrogen or alkyl, each occurrence of R₃ may be substituted or unsubstituted alkylene, cycloalkylene, alkenylene, heteroalkylene and arylene, each occurrence of R¹ may be selected from hydrogen, halogen, sulfoxide or substituted or unsubstituted alkyl, heteroaryl, silyl, alkylthio or alkoxy, both occurrences of E₁ may be C and both occurrences of E₂ may be O.

When the ligand of the catalyst of formula (I) is asymmetric, it will be appreciated that at least one of the occurrences of the groups R₁, R₂, R₃, R₄, R₅, E₁ or E₂ may be different from the remaining occurrences of the same group, or at least one occurrence of E₃, E₄, E₅ and E₆ is different to a remaining occurrence of E₃, E₄, E₅ and E₆. For example each occurrence of R₃ may be different, or each occurrence of R₁ may be different.

It will also be appreciated that E₃ and E₅ may be the same, and E₄ and E₆ may be the same, but E₃ and E₅ are different to E₄ and E₆. It will also be appreciated that E₃ and E₄ may be the same, and E₅ and E₆ may be the same, but E₃ and E₄ are different to E₅ and E₆. Alternatively one occurrence of E₃, E₄, E₅ and E₆ is different to the remaining occurrences of E₃, E₄, E₅ and E₆ (and the remaining three occurrences are the same).

For example, E₃, E₄ and E₅ may be —NR₄ where R₄ is H, and R₆ may be NR₄ where R₄ is alkyl. Furthermore, E₃ and E₅ may be NR₄ where R₄ is H, and E₄ and E₆ may be NR₄ where R₄ is alkyl, or E₃ and E₄ may be NR₄ where R₄ is H, and E₅ and E₆ may be NR₄ where R₄ is alkyl. Thus, it will be appreciated that each E₃, E₄, E₅ and E₆ is preferably NR₄, where at least one occurrence of R₄ is different to the remaining occurrences of R₄.

For the catalysts of formula (I), (symmetric and asymmetric), each X is independently selected from OC(O)R^{x}, OSO₂R^{x}, OS(O)R^{x}, OSO(R^{x})₂, S(O)R^{x}, OR^{x}, phosphinate, halide, nitro, hydroxyl, carbonate, amino, nitrate, amido and optionally substituted, aliphatic, heteroaliphatic (for example silyl), alicyclic, heteroalicyclic, aryl or heteroaryl. Preferably each X is independently OC(O)R^{x}, OSO₂R^{x}, OS(O)R^{x}, OSO(R^{x})₂, S(O)R^{x}, OR^{x}, halide, nitrate, hydroxyl, carbonate, amino, nitro, amido, alkyl (e.g. branched alkyl), heteroalkyl, (for example silyl), aryl or heteroaryl. Even more preferably, each X is independently OC(O)R^{x}, OR^{x}, halide, carbonate, amino, nitro, alkyl, aryl, heteroaryl, phosphinate or OSO₂R^{x}. Preferred optional substituents for when X is aliphatic, heteroaliphatic, alicyclic, heteroalicyclic, aryl or heteroaryl include halogen, hydroxyl, nitro, cyano, amino, or substituted or unsubstituted aliphatic, heteroaliphatic, alicyclic, heteroalicyclic, aryl or heteroaryl. Each X may be the same or different and preferably each X is the same. It will also be appreciated that X may form a bridge between the two metal centres.

R^{x} is independently hydrogen, or optionally substituted aliphatic, haloaliphatic, heteroaliphatic, alicyclic, heteroalicyclic, aryl, alkylaryl, or heteroaryl. Preferably, R^{x} is alkyl, alkenyl, alkynyl, heteroalkyl, aryl, heteroaryl, cycloalkyl, or alkylaryl. Preferred optional substituents for R^{x} include halogen, hydroxyl, cyano, nitro, amino, alkoxy, alkylthio, or substituted or unsubstituted aliphatic, heteroaliphatic, alicyclic, heteroalicyclic, aryl or heteroaryl (e.g. optionally substituted alkyl, aryl, or heteroaryl).

Exemplary options for X include OAc, OC(O)CF₃, halogen, OSO(CH₃)₂, Et, Me, OMe, OiPr, OtBu, Cl, Br, I, F, N(iPr)₂ or N(SiMe₃)₂, OPh, OBn, salicylate, dioctyl phosphinate, etc.

Preferably each X is the same, and is selected from OC(O)R^{x}, OR^{x}, halide, carbonate, amino, nitro, alkyl, aryl, heteroaryl, phosphinate or OSO₂R^{x}, R^{x} is alkyl, alkenyl, alkynyl, heteroalkyl, aryl, heteroaryl or alkylaryl. More preferably each X is the same and is OC(O)R^{x}, OR^{x}, halide, alkyl, aryl, heteroaryl, phosphinate or OSO₂R^{x}. Still more preferably each X is the same and is OC(O)R^{x} More preferably still each X is the same and is selected from OAc, O₂CCF₃, or O₂C(CH₂)₃Cy. Most preferably each X is the same and is OAc.

Preferably each R^{x} is the same and is selected from an optionally substituted alkyl, alkenyl, alkynyl, heteroalkyl, aryl, heteroaryl, cycloalkyl or alkylaryl. More preferably each R^{x} is the same and is an optionally substituted alkyl, alkenyl, heteroalkyl, aryl, heteroaryl, cycloalkyl or alkylaryl. Still more preferably each R^{x} is the same and is an optionally substituted alkyl, alkenyl, heteroalkyl; or cycloalkyl. More preferably still R^{x} is an optionally substituted alkyl, heteroalkyl or cycloalkyl. Most preferably R^{x} is an optionally substituted alkyl.

It will be appreciated that preferred definitions for X and preferred definitions for R^{x} may be combined. For example, each X may be independently OC(O)R^{x}, OSO₂R^{x}, OS(O)R^{x}, OSO(R^{x})₂, S(O)R^{x}, OR^{x}, halide, nitrate, hydroxyl, carbonate, amino, nitro, amido, alkyl (e.g. branched alkyl), heteroalkyl, (for example silyl), aryl or heteroaryl, e.g. each may be independently OC(O)R^{x}, OR^{x}, halide, carbonate, amino, nitro, alkyl, aryl, heteroaryl, phosphinate or OSO₂R^{x}, and R^{x} may be optionally substituted alkyl, alkenyl, alkynyl, heteroalkyl, aryl, heteroaryl, cycloalkyl, or alkylaryl.

As detailed above, M₁ and M₂ are independently selected from any of: Zn(II), Cr(III)-X, Cr(II), Co(III)-X, Co(II), Cu(II), Mn(III)-X, Mn(II), Mg(II), Ni(II), Ni(III)-X, Fe(II), Fe(III)-X, Ca(II), Ge(II), Ti(II), Al(III)-X, Ti(III)-X, V(II), V(III)-X, Ge(IV)-(X)₂ or Ti(IV)-(X)₂.

Preferably, at least one of M₁ and M₂ is selected from Zn(II), Cr(III)-X, Co(II), Mn(II), Mg(II), Ni(II), Fe(II), and Fe(III)-X, more preferably at least one of M₁ and M₂ is selected from Mg(II), Zn(II), and Ni(II), for example, at least one of M₁ and M₂ is Ni(II).

It will be appreciated that M₁ and M₂ may be the same or different. For example, M₁ and/or M₂ may be selected from Zn(II), Cr(III)-X, Co(II), Mn(II), Mg(II), Ni(II), Fe(II), and Fe(III)-X, more preferably M₁ and/or M₂ is selected from Mg(II), Zn(II) and Ni(II), for example, M₁ and/or M₂ is Ni(II).

Exemplary combinations of M₁ and M₂ include Mg(II) and Mg(II), Zn(II) and Zn(II), Ni(II) and Ni(II), Mg(II) and Zn(II), Mg(II) and Ni(II), Zn(II) and Co(II), Co(II) and Co(III), Fe(III) and Fe(III), Zn(II) and Fe(II), or Zn(II) and Ni(II).

It will be appreciated that when one of M₁ or M₂ is Cr(III), Co(III), Mn(III), Ni(III), Fe(III), Al(III), Ti(III) or V(III) the catalyst of formula (I) will contain an additional X group co-ordinated to the metal centre, wherein X is as defined above. It will also be appreciated that when one of M₁ or M₂ is Ge(IV) or Ti(IV), the catalyst of formula (III) will contain two additional X group co-ordinated to the metal centre, wherein X is as defined above. In certain embodiments, when one of M₁ or M₂ is Ge(IV)-(X)₂ or Ti(IV)-(X)₂, both G may be absent.

When G is not absent, it is a group which is capable of donating a lone pair of electrons (i.e. a Lewis base). In certain embodiments, G is a nitrogen-containing Lewis base. Each G may be neutral or negatively charged. If G is negatively charged, then one or more positive counterions will be required to balance out the charge of the complex. Suitable positive counterions include group 1 metal ions (Na⁺, K⁺, etc), group 2 metal ions (Mg²⁺, Ca²⁺, etc), imidazolium ions, a positively charged optionally substituted heteroaryl, heteroaliphatic or heteroalicyclic group, ammonium ions (i.e. N(R¹²)₄⁺), iminium ions (i.e. (R¹²)₂C═N(R¹²)₂⁺, such as bis(triphenylphosphine)iminium ions) or phosphonium ions (P(R¹²)₄⁺), wherein each R¹² is independently selected from hydrogen or optionally substituted aliphatic, heteroaliphatic, alicyclic, heteroalicyclic, aryl or heteroaryl. Exemplary counterions include [H—B]⁺ wherein B is selected from triethylamine, 1,8-diazabicyclo[5.4.0]undec-7-ene and 7-methyl-1,5,7-triazabicyclo[4.4.0]dec-5-ene.

G is preferably independently selected from an optionally substituted heteroaliphatic group, an optionally substituted heteroalicyclic group, an optionally substituted heteroaryl group, a halide, hydroxide, hydride, a carboxylate and water. More preferably, G is independently selected from water, an alcohol (e.g. methanol), a substituted or unsubstituted heteroaryl (imidazole, methyl imidazole (for example, N-methylimidazole), pyridine, 4-dimethylaminopyridine, pyrrole, pyrazole, etc), an ether (dimethyl ether, diethylether, cyclic ethers, etc), a thioether, carbene, a phosphine, a phosphine oxide, a substituted or unsubstituted heteroalicyclic (morpholine, piperidine, tetrahydrofuran, tetrahydrothiophene, etc), an amine, an alkyl amine trimethylamine, triethylamine, etc), acetonitrile, an ester (ethyl acetate, etc), an acetamide (dimethylacetamide, etc), a sulfoxide (dimethylsulfoxide, etc), a carboxylate, a hydroxide, hydride, a halide, a nitrate, a sulfonate, etc. In some embodiments, one or both instances of G is independently selected from optionally substituted heteroaryl, optionally substituted heteroaliphatic, optionally substituted heteroalicyclic, halide, hydroxide, hydride, an ether, a thioether, carbene, a phosphine, a phosphine oxide, an amine, an alkyl amine, acetonitrile, an ester, an acetamide, a sulfoxide, a carboxylate, a nitrate or a sulfonate. In certain embodiments, G may be a halide; hydroxide; hydride; water; a heteroaryl, heteroalicyclic or carboxylate group which are optionally substituted by alkyl, alkenyl, alkynyl, alkoxy, halogen, hydroxyl, nitro or nitrile. In preferred embodiments, G is independently selected from halide; water; a heteroaryl optionally substituted by alkyl (e.g. methyl, ethyl etc), alkenyl, alkynyl, alkoxy (preferably methoxy), halogen, hydroxyl, nitro or nitrile. In some embodiments, one or both instances of G is negatively charged (for example, halide). In further embodiments, one or both instances of G is an optionally substituted heteroaryl. Exemplary G groups include chloride, bromide, pyridine, methylimidazole (for example N-methylimidazole) and dimethylaminopyridine (for example, 4-methylaminopyridine).

It will be appreciated that when a G group is present, the G group may be associated with a single M metal centre as shown in formula (I), or the G group may be associated with both metal centres and form a bridge between the two metal centres, as shown below in formula (IIa):

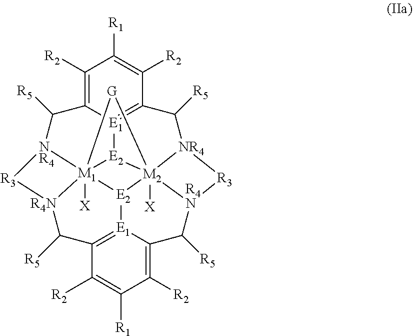

Wherein R₁, R₂, R₃, R₄, R₅, M₁, M₂, G, X, E₁ and E₂, are as defined for formula (I) and formula (II).

The skilled person will understand that, in the solid state, the catalysts of the first aspect may be associated with solvent molecules such as water, or alcohol (e.g. methanol or ethanol). It will be appreciated that the solvent molecules may be present in a ratio of less than 1:1 relative to the molecules of catalyst of the first aspect (i.e. 0.2:1, 0.25:1, 0.5:1), in a ratio of 1:1, relative to the molecules of catalyst of the first aspect, or in a ratio of greater than 1:1, relative to the molecules of catalyst of the first aspect.

The skilled person will understand that, in the solid state, the catalysts of the first aspect may form aggregates. For example, the catalyst of the first aspect may be a dimer, a trimer, a tetramer, a pentamer, or higher aggregate.

Exemplary catalysts of formula (I) are as follows:

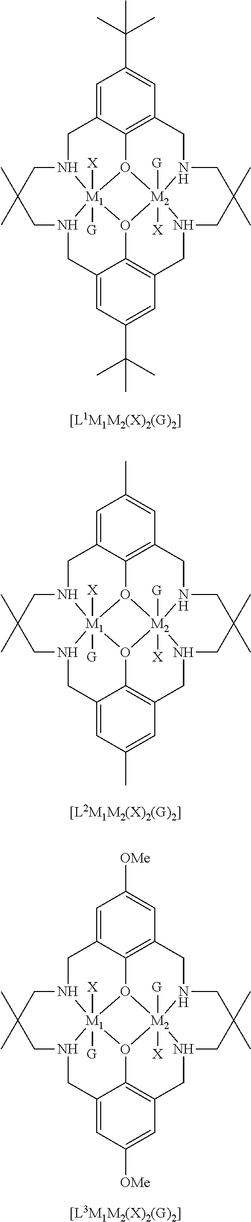

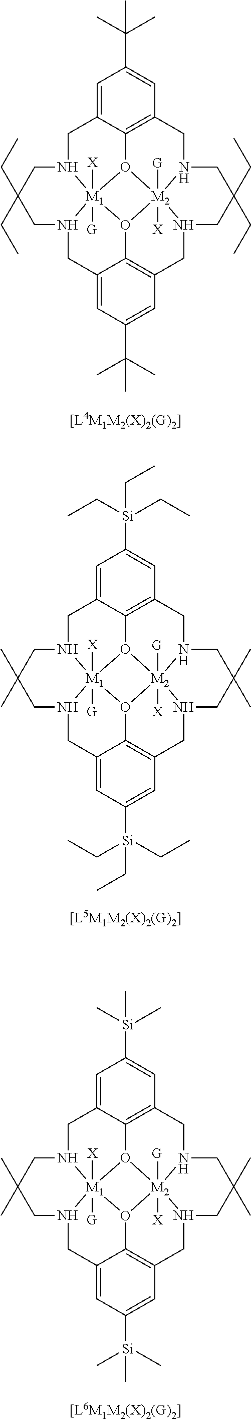

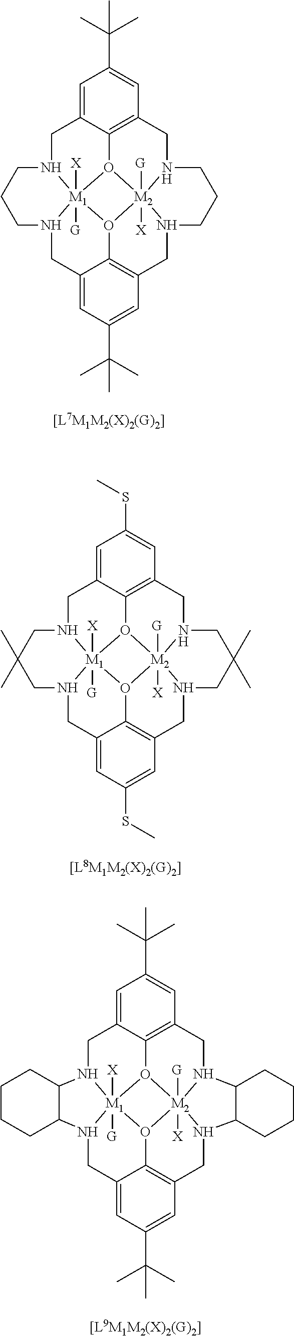

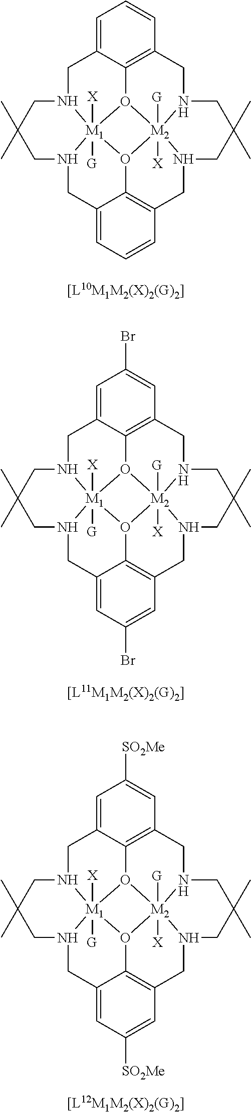

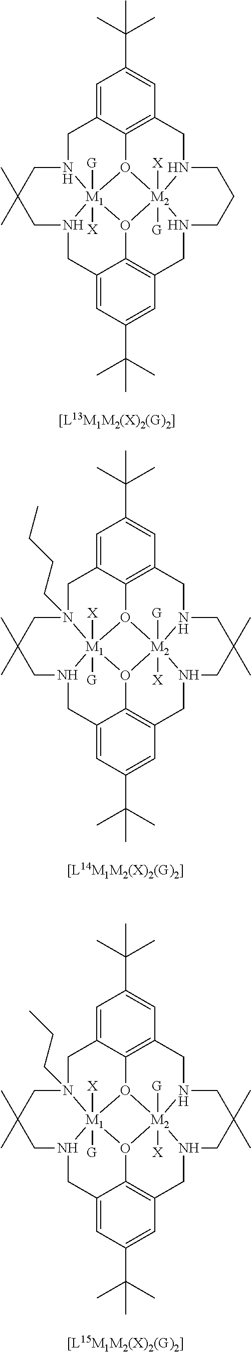

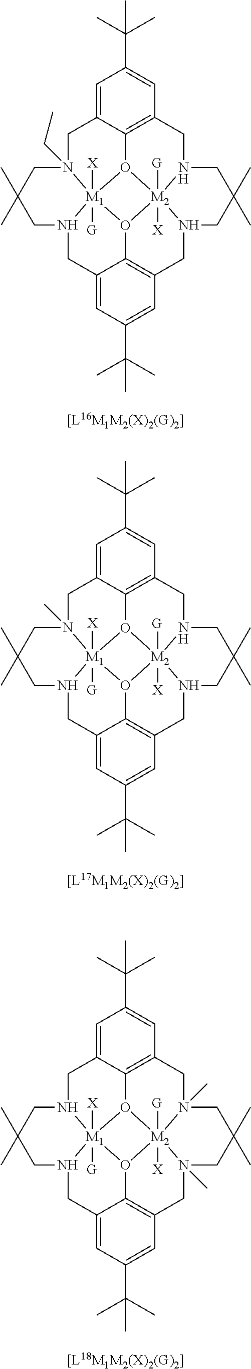

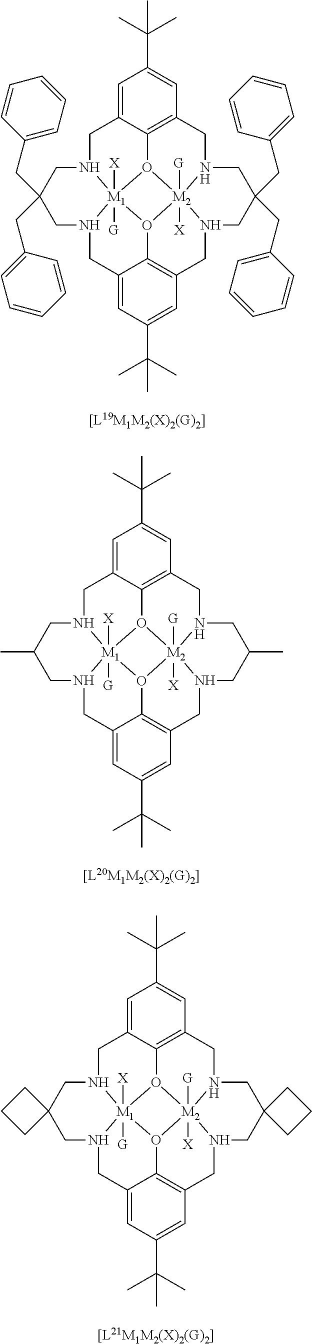

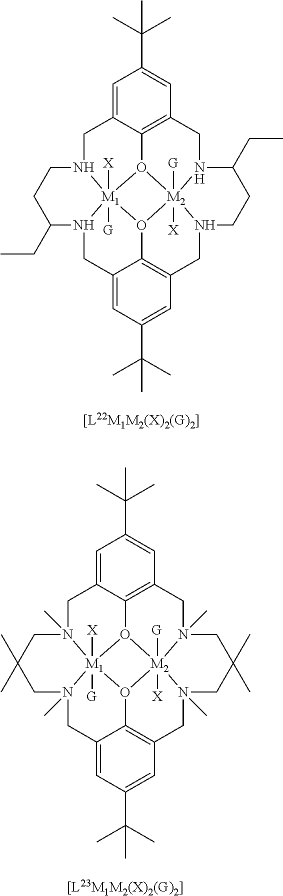

Where M₁, M₂, G and X are as defined above for formula (I), and it will be appreciated that one or both G groups may be absent.

For example, at least one of M₁ and M₂ may be selected from Zn(II), Cr(III)-X, Co(II), Mn(II), Mg(II), Ni(II), Fe(II), and Fe(III)-X, e.g. at least one of M₁ and M₂ may be selected from Mg(II), Zn(II) and Ni(II), for example, at least one of M₁ and M₂ may be Ni(II).

As set out above, M₁ and M₂ may be the same or different. For example, M₁ and/or M₂ may be selected from Zn(II), Cr(III)-X, Co(II), Mn(II), Mg(II), Ni(II), Fe(II), and Fe(III)-X, preferably M₁ and/or M₂ is selected from Mg(II), Zn(II) and Ni(II), for example, M₁ and/or M₂ is Ni(II). Exemplary combinations of M₁ and M₂ include Mg(II)/Mg(II), Zn(II)/Zn(II), Ni(II)/Ni(II), Mg(II)/Zn(II), Mg(II)/Ni(II), Zn(II)/Ni(II).

For example, each X may be independently OC(O)R^{x}, OSO₂R^{x}, OS(O)R^{x}, OSO(R^{x})₂, S(O)R^{x}, OR^{x}, halide, nitrate, hydroxyl, carbonate, amino, nitro, amido, alkyl (e.g. branched alkyl), heteroalkyl (for example silyl), aryl or heteroaryl, e.g. each may be independently OC(O)R^{x}, OR^{x}, halide, carbonate, amino, nitro, alkyl, aryl, heteroaryl, phosphinate or OSO₂R^{x}. For example, R^{x} may be alkyl, alkenyl, alkynyl, heteroalkyl, aryl, heteroaryl, cycloalkyl, or alkylaryl.

For example, if either G are present, G may be independently selected from halide; water; a heteroaryl optionally substituted by alkyl (e.g. methyl, ethyl etc), alkenyl, alkynyl, alkoxy (preferably methoxy), halogen, hydroxyl, nitro or nitrile, e.g. one or both instances of G (if present) can be chloride, bromide, pyridine, methylimidazole (for example N-methylimidazole) and dimethylaminopyridine (for example, 4-methylaminopyridine).

The skilled person will appreciate that the above definitions may be combined. For example, for the catalysts above, M₁ and M₂ may be the same or different, and may be selected from Zn(II), Cr(III)-X, Co(II), Mn(II), Mg(II), Ni(II), Fe(II), and Fe(III)-X; each X may be independently OC(O)R^{x}, OSO₂R^{x}, OS(O)R^{x}, OSO(R^{x})₂, S(O)R^{x}, OR^{x}, halide, nitrate, hydroxyl, carbonate, amino, nitro, amido, alkyl (e.g. branched alkyl), heteroalkyl (for example silyl), aryl or heteroaryl, e.g. each may be independently OC(O)R^{x}, OR^{x}, halide, carbonate, amino, nitro, alkyl, aryl, heteroaryl, phosphinate or OSO₂R^{x}; R^{x} may be alkyl, alkenyl, alkynyl, heteroalkyl, aryl, heteroaryl, cycloalkyl, or alkylaryl; G may be absent or if present, may be independently selected from halide; water; a heteroaryl optionally substituted by alkyl (e.g. methyl, ethyl etc), alkenyl, alkynyl, alkoxy (preferably methoxy), halogen, hydroxyl, nitro or nitrile.

Thus, the skilled person will understand that the above exemplary catalysts of formula (I) encompass, but are not restricted to, the following catalysts:

[L¹Ni₂(OAc)₂], [L¹Mg₂(OAc)₂], [L¹Zn₂(OAc)₂], [L¹MgZn(OAc)₂], [L¹MgNi(OAc)₂], [L¹Ni₂(CO₂CF₃)₂], [L¹Mg₂ CO₂CF₃)₂], [L¹Zn₂(CO₂CF₃)₂], [L¹MgZn(CO₂CF₃)₂], [L¹MgNi(CO₂CF₃)₂], [L¹Ni₂(CO₂^{t}Bu)₂], [L¹Mg₂(CO₂^{t}Bu)₂], [L¹Zn₂(CO₂^{t}Bu)₂], [L¹MgZn(CO₂^{t}Bu)₂], [L¹MgNi(CO₂^{t}Bu)₂], [L¹Ni₂(OPh)₂], [L¹Mg₂(OPh)₂], [L¹Zn₂(OPh)₂], [L¹MgZn(OPh)₂], [L¹MgNi(OPh)₂], [L¹Ni₂(Ph)₂], [L¹Mg₂(Ph)₂], [L¹Zn₂(Ph)₂], [L¹MgZn(Ph)₂], [L¹MgNi(Ph)₂], [L¹Ni₂(OⁱPr)₂], [L¹Mg₂(OⁱPr)₂], [L¹Zn₂(OⁱPr)₂], [L¹MgZn(OⁱPr)₂], [L¹MgNi(OⁱPr)₂], [L¹Ni₂(C₆F₅)₂], [L¹Mg₂(C₆F₅)₂], [L¹Zn₂(C₆F₅)₂], [L¹MgZn(C₆F₅)₂], [L¹MgNi(C₆F₅)₂], [L¹Ni₂Cl₂], [L¹Mg₂Cl₂], [L¹Zn₂Cl₂], [L¹MgZnCl₂], [L¹MgNiCl₂], [L¹Ni₂Br₂], [L¹Mg₂Br₂], [L¹Zn₂Br₂], [L¹MgZnBr₂], [L¹MgNiBr₂], [L¹Ni₂I₂], [L¹Mg₂I₂], [L¹Zn₂I₂], [L¹MgZnI₂], [L¹MgNiI₂], [L¹Ni₂(OC(O) (CH₂)₄CH₃)₂], [L¹Mg₂(OC(O)(CH₂)₄CH₃)₂], [L¹Zn₂(OC(O)(CH₂)₄CH₃)₂], [L¹MgZn(OC(O)(CH₂)₄CH₃)₂], [L¹MgNi(OC(O)(CH₂)₄CH₃)₂], [L¹Ni₂(OC(O) (CH₂)₆CH₃)₂], [L¹Mg₂(OC(O)(CH₂)₆CH₃)₂], [L¹Zn₂(OC(O)(CH₂)₆CH₃)₂], [L¹MgZn(OC(O)(CH₂)₆CH₃)₂], [L¹MgNi(OC(O)(CH₂)₆CH₃)₂], [L¹Ni₂(OC(O)(CH₂)₁₀CH₃)₂], [L¹Mg₂(OC(O)(CH₂)₁₀CH₃)₂], [L¹Zn₂(OC(O)(CH₂)₁₀CH₃)₂], [L¹MgZn(OC(O)(CH₂)₁₀CH₃)₂], [L¹MgNi(OC(O)(CH₂)₁₀CH₃)₂], [L¹Ni₂(OC(O)C₆F₅)₂], [L¹Mg₂(OC(O)C₆F₅)₂], [L¹Zn₂(OC(O)C₆F₅)₂], [L¹MgZn(OC(O)C₆F₅)₂], [L¹MgNi(OC(O)C₆F₅)₂], [L¹Ni₂Cl₂(methylimidazole)], [L¹Mg₂Cl₂(methylimidazole)], [L¹Zn₂Cl₂(methylimidazole)], [L¹MgZnCl₂(methylimidazole)], [L¹MgNiCl₂(methylimidazole)], [L¹Ni₂Cl₂(pyridine)], [L¹Mg₂Cl₂(pyridine)], [L¹Zn₂Cl₂(pyridine)], [L¹MgZnCl₂(pyridine)], [L¹MgNiCl₂(pyridine)], [L¹Ni₂Cl₂(dimethylaminopyridine)], [L¹Mg₂Cl₂(dimethylaminopyridine)], [L¹Zn₂Cl₂(dimethylaminopyridine)], [L¹MgZnCl₂(dimethylaminopyridine)], [L¹MgNiCl₂(dimethylaminopyridine)], [L¹Ni₂Br₂(dimethylaminopyridine)], [L¹Mg₂Br₂(dimethylaminopyridine)], [L¹Zn₂Br₂(dimethylaminopyridine)], [L¹MgZnBr₂(dimethylaminopyridine)], [L¹MgNiBr₂(dimethylaminopyridine)], [L¹Ni₂(bis(4-methoxy)phenyl phosphinate)₂], [L¹Mg₂(bis(4-methoxy)phenyl phosphinate)₂], [L¹Zn₂(bis(4-methoxy)phenyl phosphinate)₂], [L¹MgZn(bis(4-methoxy)phenyl phosphinate)₂], [L¹MgNi(bis(4-methoxy)phenyl phosphinate)₂], [L¹Ni₂(adamantyl carbonate)₂], [L¹Mg₂(adamantyl carbonate)₂], [L¹Zn₂(adamantyl carbonate)₂], [L¹MgZn(adamantyl carbonate)₂], [L¹MgNi(adamantyl carbonate)₂], [L¹Ni₂(diphenylphosphinate)₂], [L¹Mg₂(diphenylphosphinate)₂], [L¹Zn₂(diphenylphosphinate)₂], [L¹MgZn(diphenylphosphinate)₂], [L¹MgNi(diphenylphosphinate)₂], [L²Ni₂(OAc)₂], [L²Mg₂(OAc)₂], [L²Zn₂(OAc)₂], [L²MgZn(OAc)₂], [L²MgNi(OAc)₂], [L³Ni₂(OAc)₂], [L³Mg₂(OAc)₂], [L³Zn₂(OAc)₂], [L³MgZn(OAc)₂], [L³MgNi(OAc)₂], [L⁴Ni₂(OAc)₂], [L⁴Mg₂(OAc)₂], [L⁴Zn₂(OAc)₂], [L⁴MgZn(OAc)₂], [L⁴MgNi(OAc)₂], [L⁵Ni₂(OAc)₂], [L⁵Mg₂(OAc)₂], [L⁵Zn₂(OAc)₂], [L⁵MgZn(OAc)₂], [L⁵MgNi(OAc)₂], [L⁶Ni₂(OAc)₂], [L⁶Mg₂(OAc)₂], [L⁶Zn₂(OAc)₂], [L⁶MgZn(OAc)₂], [L⁶MgNi(OAc)₂], [L⁷Ni₂(OAc)₂], [L⁷Mg₂(OAc)₂], [L⁷Zn₂(OAc)₂], [L⁷MgZn(OAc)₂], [L⁷MgNi(OAc)₂], [L⁸Ni₂(OAc)₂], [L⁸Mg₂(OAc)₂], [L⁸Zn₂(OAc)₂], [L⁸MgZn(OAc)₂], [L⁸MgNi(OAc)₂], [L⁹Ni₂(OAc)₂], [L⁹Mg₂(OAc)₂], [L⁹Zn₂(OAc)₂], [L⁹MgZn(OAc)₂], [L⁹MgNi(OAc)₂], [L¹⁰Ni₂(OAc)₂], [L¹⁰Mg₂(OAc)₂], [L¹⁰Zn₂(OAc)₂], [L¹⁰MgZn(OAc)₂], [L¹⁰MgNi(OAc)₂], [L¹¹Ni₂(OAc)₂], [L¹¹Mg₂(OAc)₂], [L¹¹Zn₂(OAc)₂], [L¹¹MgZn(OAc)₂], [L¹¹MgNi(OAc)₂], [L¹²Ni₂(OAc)₂], [L¹²Mg₂(OAc)₂], [L¹²Zn₂(OAc)₂], [L¹²MgZn(OAc)₂], [L¹²MgNi(OAc)₂], [L¹³Ni₂(OAc)₂], [L¹³Mg₂(OAc)₂], [L¹³Zn₂(OAc)₂], [L¹³MgZn(OAc)₂], [L¹³MgNi(OAc)₂], [L¹⁴Ni₂(OAc)₂], [L¹⁴Mg₂(OAc)₂], [L¹⁴Zn₂(OAc)₂], [L¹⁴MgZn(OAc)₂], [L¹⁴MgNi(OAc)₂], [L¹⁵Ni₂(OAc)₂], [L¹⁵Mg₂(OAc)₂], [L¹⁵Zn₂(OAc)₂], [L¹⁵MgZn(OAc)₂], [L¹⁵MgNi(OAc)₂], [L¹⁶Ni₂(OAc)₂], [L¹⁶Mg₂(OAc)₂], [L¹⁶Zn₂(OAc)₂], [L¹⁶MgZn(OAc)₂], [L¹⁶MgNi(OAc)₂], [L¹⁷Ni₂(OAc)₂], [L¹⁷Mg₂(OAc)₂], [L¹⁷Zn₂(OAc)₂], [L¹⁷MgZn(OAc)₂], [L¹⁷MgNi(OAc)₂], [L¹⁸Ni₂(OAc)₂], [L¹⁸Mg₂(OAc)₂], [L¹⁸Zn₂(OAc)₂], [L¹⁸MgZn(OAc)₂], [L¹⁸MgNi(OAc)₂], [L¹⁹Ni₂(OAc)₂], [L¹⁹Mg₂(OAc)₂], [L¹⁹Zn₂(OAc)₂], [L¹⁹MgZn(OAc)₂], [L¹⁹MgNi(OAc)₂], [L²⁰Ni₂(OAc)₂], [L²⁰Mg₂(OAc)₂], [L²⁰Zn₂(OAc)₂], [L²⁰MgZn(OAc)₂], [L²⁰MgNi(OAc)₂], [L²¹Ni₂(OAc)₂], [L²¹Mg₂(OAc)₂], [L²¹Zn₂(OAc)₂], [L²¹MgZn(OAc)₂], [L²¹MgNi(OAc)₂], [L²²Ni₂(OAc)₂], [L²²Mg₂(OAc)₂], [L²²Zn₂(OAc)₂], [L²²MgZn(OAc)₂], [L²²MgNi(OAc)₂], [L²³Ni₂(OAc)₂], [L²³Mg₂(OAc)₂], [L²³Zn₂(OAc)₂], [L²³MgZn(OAc)₂], [L²³MgNi(OAc)₂], [L¹Co₂(OAc)₃], [L¹ZnCol₂], [L¹ZnFe(OAc)₂], [L¹ZnFeBr₂], [L¹ZnFeCl₂], [L¹ZnFel₂], [L¹ZnCo(OAc)₂], [L¹ZnCoCl₂], [L¹ZnCoBr₂], [L¹Fe₂Cl₄], [L¹Co₂Cl₂(methylimidazole)], [L¹Co₂Cl₂(pyridine)], [L¹Co₂Cl₃]⁻[H-DBU]⁺, and [L¹Co₂Cl₃]⁻[H-MTBD]⁺.

The skilled person will appreciate that in any of the above complexes, any one ligand defined by “L” may be replaced by another ligand defined by a different “L”. For example, in complexes which refer to L¹, this ligand may be replaced by any of the ligands defined by L² to L²².

### Double Metal Cyanide (DMC) Catalyst

DMC catalysts are complicated compounds which comprise at least two metal centres and cyanide ligands. The DMC catalyst additionally comprises a first and a second complexing agent, wherein the first complexing agent is a polymer.

The DMC catalyst may also comprise water and/or a metal salt and/or an acid (e.g. in non-stoichiometric amounts).

The first two of the at least two metal centres may be represented by M′ and M″.

M′ may be selected from Zn(II), Ru(II), Ru(III), Fe(II), Ni(II), Mn(II), Co(II), Sn(II), Pb(II), Fe(III), Mo(IV), Mo(VI), Al(III), V(V), V(VI), Sr(II), W(IV), W(VI), Cu(II), and Cr(III), M′ is preferably selected from Zn(II), Fe(II), Co(II) and Ni(II), even more preferably M′ is Zn(II).

M″ is selected from Fe(II), Fe(III), Co(II), Co(III), Cr(II), Cr(III), Mn(II), Mn(III), Ir(III), Ni(II), Rh(III), Ru(II), V(IV), and V(V), preferably M″ is selected from Co(II), Co(III), Fe(II), Fe(III), Cr(III), Ir(III) and Ni(II), more preferably M″ is selected from Co(II) and Co(III).

It will be appreciated that the above preferred definitions for M′ and M″ may be combined. For example, preferably M′ may be selected from Zn(II), Fe(II), Co(II) and Ni(II), and M″ may preferably selected form be Co(II), Co(III), Fe(II), Fe(III), Cr(III), Ir(III) and Ni(II). For example, M′ may preferably be Zn(II) and M″ may preferably be selected from Co(II) and Co(III).

If a further metal centre(s) is present, the further metal centre may be further selected from the definition of M′ or M″.

The second complexing agent may be selected from ethers, ketones, esters, amides, alcohols, ureas and the like. For example, the second complexing agent may be selected from propylene glycol, (m)ethoxy ethylene glycol, dimethoxyethane, tert-butyl alcohol, ethylene glycol monomethyl ether, diglyme, triglyme, methanol, ethanol, isopropyl alcohol, n-butyl alcohol, isobutyl alcohol, sec-butyl alcohol, 3-buten-1-ol, 2-methyl-3-buten-2-ol, 2-methyl-3-butyn-2-ol, 3-methyl-1-pentyn-3-ol etc. It will be appreciated that the alcohol may be saturated or may contain an unsaturated moiety (e.g. a double or triple bond).

Preferably, the second complexing agent is tert-butyl alcohol, or dimethoxymethane, more preferably, the second complexing agent is tert-butyl alcohol.

The DMC catalyst may contain further (e.g. a third) complexing agent(s). The further (eg. Third) complexing agent(s) may be selected form the definitions of the first or second complexing agents. For example, the further (e.g. third) complexing agent(s) may be selected from ethers, ketones, esters, amides, alcohols, ureas, polyethers, polycarbonate ethers or polycarbonates.

The first complexing agent is a polymer. The polymer is preferably a polyether, a polycarbonate ether or a polycarbonate. The first complexing agent (i.e. the polymer) is preferably present in an amount of from about 5% to about 80% by weight based on the total weight of the DMC catalyst, more preferably in an amount of from about 10% to about 70% by weight based on the total weight of the DMC catalyst, more preferably in an amount of from about 20% to about 50% by weight based on the total weight of the DMC catalyst.

Suitable polyethers for use in the present invention include those produced by ring-opening polymerisation of cyclic ethers, and include epoxide polymers, oxetane polymers, tetrahydrofuran polymers, and the like. Any method of catalysis can be used to make the polyethers. The polyethers can have any desired end groups, including, for example, hydroxyl, amine, ester, ether, or the like. Preferred polyethers for use in the present invention are polyether polyols having between 2 and 8 hydroxyl groups. It is also preferred that polyethers for use in the present invention have a molecular weight between about 1,000 Daltons and about 10,000 Daltons, more preferably between about 1,000 Daltons and about 5,000 Daltons. Polyether polyols useful in the DMC catalyst of the present invention include PPG polyols, EO-capped PPG polyols, mixed EO-PO polyols, butylene oxide polymers, butylene oxide copolymers with ethylene oxide and/or propylene oxide, polytetramethylene ether glycols, and the like. Preferred polyethers include PPGs, such as PPG polyols, particularly diols and triols, said PPGs having molecular weights of from about 250 Daltons to about 8,000 Daltons, more preferably from about 400 Daltons to about 4,000 Daltons.

Suitable polycarbonate ethers for use in the DMC catalyst of the present invention may be obtained by the catalytic reaction of alkylene oxides and carbon dioxide in the presence of a suitable starter or initiator compound. The polycarbonate ethers can also be produced by other methods known to the person skilled in the art, for example by partial alcoholysis of polycarbonate polyols with di- or tri-functional hydroxy compounds. The polycarbonate ethers preferably have an average hydroxyl functionality of 1 to 6, more preferably 2 to 3, most preferably 2.

Suitable polycarbonates for use in the DMC catalyst of the present invention may be obtained by the polycondensation of difunctional hydroxy compounds (generally bis-hydroxy compounds such as alkanediols or bisphenols) with carbonic acid derivatives such as, for example, phosgene or bis[chlorocarbonyloxy] compounds, carbonic acid diesters (such as diphenyl carbonate or dimethyl carbonate) or urea. Methods for producing polycarbonates are generally well known and are described in detail in for example “Houben-Weyl, Methoden der organischen Chemie”, Volume E20, Makromolekulare Stoffe, 4^{th} Edition, 1987, p. 1443-1457, “Ullmann's Encyclopedia of Industrial Chemistry”, Volume A21, 5^{th} Edition, 1992, p. 207-215 and “Encyclopedia of Polymer Science and Engineering”, Volume 11, 2^{nd} Edition, 1988, p. 648-718. Aliphatic polycarbonate diols having a molecular weight of from about 500 Daltons to 5000 Daltons, most highly preferably from 1000 Daltons to 3000 Daltons, are particularly preferably used. These are generally obtained from non-vicinal diols by reaction with diaryl carbonate, dialkyl carbonate, dioxolanones, phosgene, bischloroformic acid esters or urea (see for example EP-A 292 772 and the documents cited therein). Suitable non-vicinal diols are in particular 1,4-butanediol, neopentyl glycol, 1,5-pentanediol, 2-methyl-1,5-pentanediol, 3-methyl-1,5-pentanediol, 1,6-hexanediol, bis-(6-hydroxyhexyl)ether, 1,7-heptanediol, 1,8-octanediol, 2-methyl-1,8-octanediol, 1,9-nonanediol, 1,10-decanediol, 1,4-bis-hydroxymethyl cyclohexane, diethylene glycol, triethylene glycol, tetraethylene glycol, dipropylene glycol, tripropylene glycol, tetrapropylene glycol, alkoxylation products of diols with ethylene oxide and/or propylene oxide and/or tetrahydrofuran with molar masses up to 1000 Daltons, preferably between 200 Daltons and 700 Daltons, and in rarer cases the dimer diols, which are obtainable by reducing both carboxyl groups of dimer acids, which in turn can be obtained by dimerisation of unsaturated vegetable fatty acids. The non-vicinal diols can be used individually or in mixtures. The reaction can be catalysed by bases or transition metal compounds in the manner known to the person skilled in the art.

Other polymers that may be useful in present invention include poly(tetramethylene ether diols). Poly(tetramethylene ether diols) are polyether polyols based on tetramethylene ether glycol, also known as polytetrahydrofuran (PTHF) or polyoxybutylene glycol. These poly(tetramethylene ether diols) comprise two OH groups per molecule. They can be produced by cationic polymerisation of tetrahydrofuran (THF) with the aid of catalysts.

Preferably, the first complexing agent is a polyether, and the second complexing agent is tert-butyl alcohol. Preferably, the polyether is a PPG (e.g. a PPG polyol) having a molecular weight of from about 250 Daltons to about 8,000 Daltons, more preferably from about 400 Daltons to about 4,000 Daltons Suitable acids for use in the DMC catalyst of the present invention may have the formula HᵣX′″, where X′″ is an anion selected from halide, sulfate, phosphate, borate, chlorate, carbonate, cyanide, oxalate, thiocyanate, isocyanate, isothiocyanate, carboxylate and nitrate, preferably X′″ is a halide. r is an integer corresponding to the charge on the counterion X′″. For example, when X′″ is Cl⁻, r will be 1, i.e. the salt will be HCl.

If present, preferred acids for use in the DMC catalyst of the present invention having the formula HᵣX′″ include the following: HCl, H₂SO₄, HNO₃, H₃PO₄, HF, HI, HBr, H₃BO₃ and HCIO₄. HCl, HBr and H₂SO₄ are particularly preferred.

It will also be appreciated that an alkali metal salt (e.g. an alkali metal hydroxide such as KOH) may be added to the reaction mixture during synthesis of the DMC catalyst. For example, the alkali metal salt may be added to the reaction mixture after the metal salt (M′(X′)ₚ) has been added to the metal cyanide salt ((Y)q[M″(CN)_{b}(A)_{c}]).

The DMC catalysts which are useful in the invention may be produced by treating a solution (such as an aqueous solution) of a metal salt with a solution (such as an aqueous solution) of a metal cyanide salt in the presence of a first and a second complexing agent, where the first complexing agent is a polymer. Suitable metal salts include compounds of the formula M′(X′)ₚ wherein M′ is selected from Zn(II), Ru(II), Ru(III), Fe(II), Ni(II), Mn(II), Co(II), Sn(II), Pb(II), Fe(III), Mo(IV), Mo(VI), Al(III), V(V), V(VI), Sr(II), W(IV), W(VI), Cu(II), and Cr(III), and M′ is preferably selected from Zn(II), Fe(II), Co(II) and Ni(II), even more preferably M′ is Zn(II). X′ is an anion selected from halide, hydroxide, oxide, sulphate, carbonate, cyanide, oxalate, thiocyanate, isocyanate, isothiocyanate, carboxylate and nitrate, preferably X′ is halide. p is an integer of 1 or more, and the charge on the anion multiplied by p satisfies the valency of M′. Examples of suitable metal salts include zinc chloride, zinc bromide, zinc acetate, zinc acetonylacetonate, zinc benzoate, zinc nitrate, iron(II) sulphate, iron (II) bromide, cobalt(II) chloride, cobalt(II) thiocyanate, nickel(II) formate, nickel(II) nitrate, and mixtures thereof.

Suitable metal cyanide salts include compounds of the formula (Y)q[M″(CN)_{b}(A)_{c}], wherein M″ is selected from Fe(II), Fe(III), Co(II), Co(III), Cr(II), Cr(III), Mn(II), Mn(III), Ir(III), Ni(II), Rh(III), Ru(II), V(IV), and V(V), preferably M″ is selected from Co(II), Co(III), Fe(II), Fe(III), Cr(III), Ir(III) and Ni(II), more preferably M″ is selected from Co(II) and Co(III).Y is a proton or an alkali metal ion or an alkaline earth metal ion (such as K⁺), A is an anion selected from halide, hydroxide, oxide, sulphate, cyanide oxalate, thiocyanate, isocyanate, isothiocyanate, carboxylate and nitrate. q and b are integers of 1 or more, preferably b is 4 or 6. c may be 0 or an integer of 1 or more. The sum of the charges on the ions Y, CN and A multiplied by q, b and c respectively (e.g. Y×q+CN×b+A×c) satisfies the valency of M″. Examples of suitable metal cyanide salts include potassium hexacyanocobaltate(III), potassium hexacyanoferrate(II), potassium hexacyanoferrate(III), calcium hexacyanocobaltate(III), lithium hexacyanocolbaltate(III), and mixtures thereof.

Suitable second complexing agents include ethers, ketones, esters, amides, alcohols, ureas and the like, such as propylene glycol, (m)ethoxy ethylene glycol, dimethoxyethane, tert-butyl alcohol, ethylene glycol monomethyl ether, diglyme, triglyme, methanol, ethanol, isopropyl alcohol, n-butyl alcohol, isobutyl alcohol, sec-butyl alcohol, 3-buten-1-ol, 2-methyl-3-buten-2-ol, 2-methyl-3-butyn-2-ol, 3-methyl-1-pentyn-3-ol etc. It will be appreciated that the alcohol may be saturated or may contain an unsaturated moiety (e.g. a double or triple bond).

The first complexing agent is a polymer. The first complexing agent is preferably a polymer selected from a polyether, a polycarbonate ether and a polycarbonate. Suitable polyethers, polycarbonate ethers and polycarbonates for use as the first complexing agent are described above.

In one common preparation, several separate solutions may be prepared and then combined in order. For example, the following solutions may be prepared:
1. a solution of a metal cyanide (e.g. potassium hexacyanocobaltate)
2. a solution of a metal salt e.g. (zinc chloride (excess))
3. a solution of a second complexing agent (e.g. tert-butyl alcohol)
4. a solution of a first complexing agent, which is a polymer (e.g. PPG diol).

In this method, solutions 1 and 2 are combined immediately, followed by slow addition of solution 3, preferably whilst stirring rapidly. Solution 4 may be added once the addition of solution 3 is complete, or shortly thereafter. The catalyst is removed from the reaction mixture via filtration, and is subsequently washed with a solution of the first and second complexing agents.

If water is desired in the DMC catalyst, then the above solutions (e.g. solutions 1 to 4) may be aqueous solutions.

However, it will be understood that anhydrous DMC catalysts (i.e. DMC catalysts without any water present) may be prepared if the solutions described in the above preparations are anhydrous solutions. To avoid hydrating the DMC catalyst and thereby introducing water molecules, any further processing steps (washing, filtration etc.) may be conducted using anhydrous solvents.

In one common preparation, several separate solutions may be prepared and then combined in order. For example, the following solutions may be prepared:
1. a solution of a metal salt (e.g. zinc chloride (excess)) and a second complexing agent (e.g. tert-butyl alcohol)
2. a solution of a metal cyanide (e.g. potassium hexacyanocobaltate)
3. a solution of a first and a second complexing agent, the first of which is a polymer (e.g. a solution of polypropylene glycol diol and tert-butyl alcohol)

In this method, solutions 1 and 2 are combined slowly (e.g. over 1 hour) at a raised temperature (e.g. above 25° C., such as about 50° C.) while stirring (e.g. at 450 rpm). After addition is complete the stirring rate is increased for 1 hour (e.g. up to 900 rpm). The stirring rate is then decreased to a slow rate (e.g. to 200 rpm) and solution 3 is added quickly with low stirring. The mixture is filtered.

The catalyst solids may be re-slurried in a solution of the second complexing agent at high stirring rate (e.g. about 900 rpm) before addition of the first complexing agent at low stirring rate (e.g. 200 rpm). The mixture is then filtered. This step may be repeated more than once. The resulting catalyst cake may be dried under vacuum (with heating e.g. to 60° C.).

Alternatively, after the mixture is first filtered it can be re-slurried at a raised temperature (e.g. above 25° C., such as about 50° C.) in a solution of the first complexing agent (and no second or further complexing agent) and then homogenized by stirring. It is then filtered after this step. The catalyst solids are then re-slurried in a mixture of the first and second complexing agents. For example, the catalyst solids are re-slurried in the second complexing agent at a raised temperature (e.g above 25° C., such as about 50° C.) and subsequently the first complexing agent is added and mixture homogenized by stirring. The mixture is filtered and the catalyst is dried under vacuum with heating (e.g. to 100° C.).

For example, the DMC catalyst may comprise:

M′_{d}[M″ₑ(CN)_{f}]_{g}

Wherein M′ and M″ are as defined above, d, e, f and g are integers, and are chosen to such that the DMC catalyst has electroneutrality. Preferably, d is 3. Preferably, e is 1. Preferably f is 6. Preferably g is 2. Preferably, M′ is selected from Zn(II), Fe(II), Co(II) and Ni(II), more preferably M′ is Zn(II). Preferably M″ is selected from Co(III), Fe(III), Cr(III) and Ir(III), more preferably M″ is Co(III).

It will be appreciated that any of these preferred features may be combined, for example, d is 3, e is 1, f is 6 and g is 2, M′ is Zn(II) and M″ is Co(III).

Suitable DMC catalysts of the above formula may include zinc hexacyanocobaltate(III), zinc hexacyanoferrate(III), nickel hexacyanoferrate(II), and cobalt hexacyanocobaltate(III).

There has been a lot of development in the field of DMC catalysts, and the skilled person will appreciate that the DMC catalyst may comprise, in addition to the formula above, further additives to enhance the activity of the catalyst. Thus, while the above formula may form the “core” of the DMC catalyst, the DMC catalyst additionally comprises stoichiometric or non-stoichiometric amounts of a first and a second complexing agent, where the first complexing agent is a polymer. The DMC catalyst may also comprise stoichiometric or non-stoichiometric amounts of one or more additional components, such as an acid, a metal salt, and/or water.

For example, the DMC catalyst may have the following formula:

M′_{d}[M″ₑ(CN)_{f}]_{g}.hM′″X″ᵢ.jR^{c}.kH₂O.IHᵣX′″.Pol

Wherein M′, M″, d, e, f and g are as defined above. M′″ can be M′ and/or M″. X″ is an anion selected from halide, hydroxide, oxide, sulphate, carbonate, cyanide, oxalate, thiocyanate, isocyanate, isothiocyanate, carboxylate and nitrate, preferably X′ is halide. i is an integer of 1 or more, and the charge on the anion X″ multiplied by i satisfies the valency of M′″. r is an integer that corresponds to the charge on the counterion X′″. For example, when X′″ is Cl⁻, r will be 1. l is a number between 0.1 and 5. Preferably, l is between 0.15 and 1.5.

R^{c} is the second complexing agent, and may be as defined above. For example, R^{c} may be an ether, a ketone, an ester, an amide, an alcohol (e.g. a C₁₋₈ alcohol), a urea and the like. Examples of R^{c} include propylene glycol, (m)ethoxy ethylene glycol, dimethoxyethane, tert-butyl alcohol, ethylene glycol monomethyl ether, diglyme, triglyme, methanol, ethanol, isopropyl alcohol, n-butyl alcohol, isobutyl alcohol, sec-butyl alcohol, 3-buten-1-ol, 2-methyl-3-buten-2-ol, 2-methyl-3-butyn-2-ol, 3-methyl-1-pentyn-3-ol, for example, R^{c} may be tert-butyl alcohol or dimethoxyethane. Most preferably R^{c} is tert-butyl alcohol.

j is a positive number, and may be between 0.1 and 6.

It will be appreciated that if the water, metal salt and/or acid are not present in the DMC catalyst, h, k and/or l will be zero respectively. If the water, metal salt and/or acid are present, then h, k and/or l are a positive number and may, for example, be between 0 and 20. For example, h may be between 0.1 and 4. k may be between 0 and 20, e.g. between 0.1 and 10, such as between 0.1 and 5.

Pol represents the first complexing agent, which is a polymer. Pol is preferably selected from a polyether, a polycarbonate ether, and a polycarbonate. The first complexing agents (e.g. “Pol”) is present in an amount of from about 5% to about 80% by weight of the DMC catalyst, preferably in an amount of from about 10% to about 70% by weight of the DMC catalyst, more preferably in an amount of from about 20% to about 50% by weight of the DMC catalyst.

As set out above, DMC catalysts are complicated structures, and thus, the above formula including the additional components is not intended to be limiting. Instead, the skilled person will appreciate that this definition is not exhaustive of the DMC catalysts which are capable of being used in the invention.

### Starter Compound

The starter compound which may be used in the method of the invention comprises at least two groups selected from a hydroxyl group (—OH), a thiol (—SH), an amine having at least one N—H bond (—NHR′), a group having at least one P—OH bond (e.g. —PR′(O)OH, PR′(O)(OH)₂ or —P(O)(OR′)(OH)), or a carboxylic acid group (—C(O)OH).

Thus, the starter compound which is useful in the method of the invention may be of the formula (III):

ZR^{Z})ₐ (III)

Z can be any group which can have 2 or more —R^{Z} groups attached to it. Thus, Z may be selected from optionally substituted alkylene, alkenylene, alkynylene, heteroalkylene, heteroalkenylene, heteroalkynylene, cycloalkylene, cycloalkenylene, hererocycloalkylene, heterocycloalkenylene, arylene, heteroarylene, or Z may be a combination of any of these groups, for example Z may be an alkylarylene, heteroalkylarylene, heteroalkylheteroarylene or alkylheteroarylene group. Preferably Z is alkylene, heteroalkylene, arylene, or heteroarylene.

It will be appreciated that a is an integer which is at least 2, preferably a is in the range of between 2 and 8, preferably a is in the range of between 2 and 6.

Each R^{Z} may be —OH, —NHR′, —SH, —C(O)OH, —P(O)(OR′)(OH), —PR′(O)(OH)₂ or —PR′(O)OH, preferably R^{Z} is selected from —OH, —NHR′ or —C(O)OH, more preferably each R^{Z} is —OH, —C(O)OH or a combination thereof (e.g. each R^{z} is —OH).

R′ may be H, or optionally substituted alkyl, heteroalkyl, aryl, heteroaryl, cycloalkyl or heterocycloalkyl, preferably R′ is H or optionally substituted alkyl.

It will be appreciated that any of the above features may be combined. For example, a may be between 2 and 8, each R^{Z} may be —OH, —C(O)OH or a combination thereof, and Z may be selected from alkylene, heteroalkylene, arylene, or heteroarylene.

Exemplary starter compounds include diols such as 1,2-ethanediol (ethylene glycol), 1-2-propanediol, 1,3-propanediol (propylene glycol), 1,2-butanediol, 1-3-butanediol, 1,4-butanediol, 1,5-pentanediol, 1,6-hexanediol, 1,8-octanediol, 1,10-decanediol, 1,4-cyclohexanediol, 1,2-diphenol, 1,3-diphenol, 1,4-diphenol, neopentyl glycol, catechol, cyclohexenediol, 1,4-cyclohexanedimethanol, dipropylene glycol, diethylene glycol, tripropylene glycol, triethylene glycol, tetraethylene glycol, polypropylene glycols (PPGs) or polyethylene glycols (PEGs) having an Mn of up to about 1500 g/mol, such as PPG 425, PPG 725, PPG 1000 and the like, triols such as glycerol, benzenetriol, 1,2,4-butanetriol, 1,2,6-hexanetriol, tris(methylalcohol)propane, tris(methylalcohol)ethane, tris(methylalcohol)nitropropane, trimethylol propane, polypropylene oxide triols and polyester triols, tetraols such as calix[4]arene, 2,2-bis(methylalcohol)-1,3-propanediol, erythritol, pentaerythritol or polyalkylene glycols (PEGs or PPGs) having 4—OH groups, polyols, such as sorbitol or polyalkylene glycols (PEGs or PPGs) having 5 or more —OH groups, or compounds having mixed functional groups including ethanolamine, diethanolamine, methyldiethanolamine, and phenyldiethanolamine.

For example, the starter compound may be a diol such as 1,2-ethanediol (ethylene glycol), 1-2-propanediol, 1,3-propanediol (propylene glycol), 1,2-butanediol, 1-3-butanediol, 1,4-butanediol, 1,5-pentanediol, 1,6-hexanediol, 1,8-octanediol, 1,10-decanediol, 1,12-dodecanediol, 1,4-cyclohexanediol, 1,2-diphenol, 1,3-diphenol, 1,4-diphenol, neopentyl glycol, catechol, cyclohexenediol, 1,4-cyclohexanedimethanol, poly(caprolactone) diol, dipropylene glycol, diethylene glycol, tripropylene glycol, triethylene glycol, tetraethylene glycol, polypropylene glycols (PPGs) or polyethylene glycols (PEGs) having an Mn of up to about 1500 g/mol, such as PPG 425, PPG 725, PPG 1000 and the like. It will be appreciated that the starter compound may be 1,6-hexanediol, 1,4-cyclohexanedimethanol, 1,12-dodecanediol, poly(caprolactone) diol, PPG 425, PPG 725, or PPG 1000.

Further exemplary starter compounds may include diacids such as oxalic acid, malonic acid, succinic acid, glutaric acid, adipic acid, pimelic acid, suberic acid, azelaic acid, sebacic acid, undecanedioic acid, dodecanedioic acid or other compounds having mixed functional groups such as lactic acid, glycolic acid, 3-hydroxypropanoic acid, 4-hydroxybutanoic acid, 5-hydroxypentanoic acid.

### Reaction Conditions

The method of the invention may be carried out at pressures of between about 1 bar and about 60 bar carbon dioxide, e.g. between about 1 bar and about 30 bar carbon dioxide, for example between about 1 to about 20 bar, such as between about 1 and about 15 bar carbon dioxide.

The method of the invention is capable of preparing polycarbonate ether polyols at pressures that are within the limits of existing polyether polyol equipment used in industry (e.g. 10 bar or less). Therefore, the method of the invention is capable being carried out at pressures of between about 1 bar and about 10 bar, for example, the reaction is capable of being carried out at a pressure of about 5 bar or less carbon dioxide. Under these conditions, the method of the invention is still capable of producing polycarbonate ether polyols having a varying amount of carbonate linkages, and may produce a polyol having a high content of carbonate linkages.

The method of the invention may be carried out in the presence of a solvent, however it will also be appreciated that the reaction may be carried out in the absence of a solvent. When a solvent is present, it may be toluene, hexane, t-butyl acetate, diethyl carbonate, dimethyl carbonate, dioxane, dichlorobenzene, methylene chloride, propylene carbonate, ethylene carbonate, acetone, ethyl acetate, propyl acetate, n-butyl acetate, tetrahydrofuran (THF), etc.

The epoxide which is used in the method may be any containing an epoxide moiety. Exemplary epoxides include ethylene oxide, propylene oxide, butylene oxide and cyclohexene oxide.

The epoxide may be purified (for example by distillation, such as over calcium hydride) prior to reaction with carbon dioxide. For example, the epoxide may be distilled prior to being added to the reaction mixture comprising the catalysts.

The process may be carried out at a temperature of about 0° C. to about 250° C., for example from about 40° C. to about 140° C., e.g. from about 50° C. to about 110° C., such as from about 60° C. to about 100° C., for example from about 70° C. to about 100° C., e.g. from about 55° C. to about 80° C. The duration of the process may be up to about 168 hours, such as from about 1 minute to about 24 hours, for example from about 5 minutes to about 12 hours, e.g. from about 1 to about 6 hours.

The method of the invention may be carried out at low catalytic loading. For example, the catalytic loading of the catalyst of formula (I) may be in the range of about 1:1,000-300,000 [catalyst of formula (I)]:[epoxide], such as about 1:1,000-100,000 [catalyst of formula (I)]:[epoxide], e.g. in the region of about 1:10000-50,000 [catalyst of formula (I)]:[epoxide], for example in the region of about 1:10,000 [catalyst of formula (I)]:[epoxide]. The ratios above are molar ratios.

The ratio of the catalyst of formula (I) to the DMC catalyst may be in the range of from about 300:1 to about 0.1:1, for example, from about 120:1 to about 0.25:1, such as from about 40:1 to about 0.5:1, e.g. from about 30:1 to about 0.75:1 such as from about 20:1 to about 1:1, for example from about 10:1 to about 2:1, e.g. from about 5:1 to about 3:1. These ratios are mass ratios.

The starter compound may be present in amounts of from about 200:1 to about 1:1, for example, from about 175:1 to about 5:1, such as from about 150:1 to about 10:1, e.g. from about 125:1 to about 20:1, for example, from about 50:1 to about 20:1, relative to the catalyst of formula (I). These ratios are molar ratios.

The starter may be pre-dried (for example with molecular sieves) to remove moisture. It will be understood that any of the above reaction conditions described may be combined. For example, the reaction may be carried out at 20 bar or less (e.g. 10 bar or less) and at a temperature in the range of from about 50° C. to about 130° C., for example, from about 50° C. to about 110° C., such as from about 60° C. to about 100° C., e.g. from about 70° C. to about 100° C.

The method may be a batch reaction, a semi-continuous reaction, or a continuous reaction.

### Polyols

The method of the invention is capable of preparing polycarbonate ether polyols, which are capable of being used, for example, to prepare polyurethanes.

The method of the invention is capable of producing polycarbonate ether polyols in which the amount of ether and carbonate linkages can be controlled. Thus, the invention provides a polycarbonate ether polyol which has n ether linkages and m carbonate linkages, wherein n and m are integers, and wherein m/(n+m) is from greater than zero to less than 1. It will therefore be appreciated that n≤1 and m≤1.

For example, the method of the invention is capable of preparing polycarbonate ether polyols having a wide range of m/(n+m) values. It will be understood that m/(n+m) may be about 0.05, about 0.10, about 0.15, about 0.20, about 0.25, about 0.25, about 0.30, about 0.35, about 0.40, about 0.45, about 0.50, about 0.55, about 0.60, about 0.65, about 0.70, about 0.75, about 0.80, about 0.85, about 0.90, about 0.95, or within any range prepared from these specific values. For example, m/(n+m) may be from about 0.05 to about 0.95, from about 0.10 to about 0.90, from about 0.15 to about 0.85, from about 0.20 to about 0.80, or from about 0.25 to about 0.75, etc.

Thus, the method of the invention makes it possible to prepare polycarbonate ether polyols having a high proportion of carbonate linkages, e.g. m/(n+m) may be greater than about 0.50, such as from greater than about 0.55 to less than about 0.95, e.g. about 0.65 to about 0.90, e.g. about 0.75 to about 0.90. The method of the invention is able to prepare polyols having a high ratio of m/(n+m) under mild conditions, for example, under pressures of about 20 bar or below, such as 10 bar or below.

For example, the polycarbonate ether polyols produced by the method of the invention may have the following formula (IV):

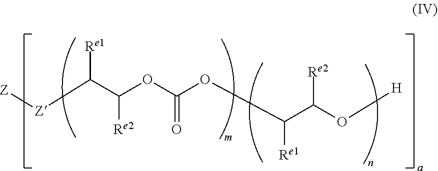

It will be appreciated that the identity of Z and Z′ will depend on the nature of the starter compound, and that the identity of R^{e1} and R^{e2} will depend on the nature of the epoxide used to prepare the polycarbonate ether polyol. m and n define the amount of the carbonate and ether linkages in the polycarbonate ether polyol.

The skilled person will understand that in the polymers of formula (IV), the adjacent epoxide monomer units in the backbone may be head-to-tail linkages, head-to-head linkages or tail-to-tail linkages.

It will also be appreciated that formula (IV) does not require the carbonate links and the ether links to be present in two distinct “blocks” in each of the sections defined by “a”, but instead the carbonate and ether repeating units may be statistically distributed along the polymer backbone, or may be arranged so that the carbonate and ether linkages are not in two distinct blocks.

Thus, the polycarbonate ether polyol prepared by the method of the invention (e.g. a polymer of formula (IV)) may be referred to as a random copolymer, a statistical copolymer, an alternating copolymer, or a periodic copolymer.

The skilled person will appreciate that the wt % of carbon dioxide incorporated into a polymer cannot be definitively used to determine the amount of carbonate linkages in the polymer backbone. For example, two polymers which incorporate the same wt % of carbon dioxide may have very different ratios of carbonate to ether linkages. This is because the “wt % incorporation” of carbon dioxide does not take into account the length and nature of the starter compound. For instance, if one polymer (Mn 2000 g/mol) is prepared using a starter with a molar mass of 100 g/mol, and another polymer (Mn also 2000 g/mol) is prepared using a starter having a molar mass of 500 g/mol, and both the resultant polymers have the same ratio of m/n then the wt % of carbon dioxide in the polymers will be different due to the differing proportion of the mass of the starter in the overall polymer molecular weight (Mn). For example, if m/(m+n) was 0.5, the two polyols described would have carbon dioxide contents of 26.1 wt % and 20.6 wt % respectively.

As highlighted above, the method of the invention is capable of preparing polyols which have a wide range of carbonate to ether linkages (e.g. m/(n+m) can be from greater than zero to less than 1), which, when using propylene oxide, corresponds to incorporation of up to about 43 wt % carbon dioxide. This is surprising, as DMC catalysts which have previously reported can generally only prepare polyols having a ratio of carbonate to ether linkages of up to 0.75, and these amounts can usually only be achieved at high pressures of carbon dioxide, such as 30 bar, more commonly 40 bar or above.

Furthermore, catalysts which are used to prepare polycarbonate polyols can typically achieve a ratio of carbonate to ether linkages of about 0.95 or above (usually about 0.98 or above), and thus also incorporate a high wt % of carbon dioxide. However, these catalysts are not capable of preparing polyols having a ratio of carbonate to ether linkages below 0.95. The carbon dioxide wt % can be moderated by changing the mass of the starter: the resultant polyols contain blocks of polycarbonate. For many applications this is not desirable, as polycarbonates produced from epoxides and carbon dioxide are less thermally stable than polyethers and block copolymers can have very different properties from random or statistical copolymers.

All other things being equal, polyethers have higher temperatures of degradation than polycarbonates produced from epoxides and carbon dioxide. Therefore, a polyol having a statistical or random distribution of ether and carbonate linkages will have a higher temperature of degradation than a polycarbonate polyol, or a polyol having blocks of carbonate linkages. Temperature of thermal degradation can be measured using thermal gravimetric analysis (TGA).

As set out above, the method of the invention prepares a random copolymer, a statistical copolymer, an alternating copolymer, or a periodic copolymer. Thus, the carbonate linkages are not in a single block, thereby providing a polymer which has improved properties, such as improved thermal degradation, as compared to a polycarbonate polyol. Preferably, the polymer prepared by the method of the invention is a random copolymer or a statistical copolymer.

The polycarbonate ether polyol prepared by the method of the invention may be of formula (IV), in which n and m are integers of 1 or more, the sum of all m and n groups is from 4 to 200, and wherein m/(m+n) is in the range of from greater than zero to less than 1.00. As set out above, m/(n+m) may be from about 0.05, about 0.10, about 0.15, about 0.20, about 0.25, about 0.25, about 0.30, about 0.35, about 0.40, about 0.45, about 0.50, about 0.55, about 0.60, about 0.65, about 0.70, about 0.75, about 0.80, about 0.85, about 0.90, about 0.95, or within any range prepared from these specific values. For example, m/(n+m) may be from about 0.05 to about 0.95, from about 0.10 to about 0.90, from about 0.15 to about 0.85, from about 0.20 to about 0.80, or from about 0.25 to about 0.75, etc.

The skilled person will also appreciate that the polyol must contain at least one carbonate and at least one ether linkage. Therefore it will be understood that the number of ether and carbonate linkages (n+m) in the polyol will be ≥a. The sum of n+m must be greater than or equal to “a”.

Each R^{e1} may be independently selected from H, halogen, hydroxyl, or optionally substituted alkyl, alkenyl, alkynyl, cycloalkyl, heterocycloalkyl, aryl, heteroaryl, heteroalkyl or heteroalkenyl. Preferably R^{e1} may be selected from H or optionally substituted alkyl.

Each R^{e2} may be independently selected from H, halogen, hydroxyl, or optionally substituted alkyl, alkenyl, alkynyl, cycloalkyl, heterocycloalkyl, aryl, heteroaryl, heteroalkyl or heteroalkenyl. Preferably R^{e2} may be selected from H or optionally substituted alkyl.

It will also be appreciated that R^{e1} and R^{e2} may together form a saturated, partially unsaturated or unsaturated ring containing carbon and hydrogen atoms, and optionally one or more heteroatoms (e.g. O, N or S). For example, R^{e1} and R^{e2} may together form a 5 or six membered ring.

As set out above, the nature of R^{e1} and R^{e2} will depend on the epoxide used in the reaction. If the epoxide is cyclohexene oxide (CHO), then R^{e1} and R^{e2} will together form a six membered alkyl ring (e.g. a cyclohexyl ring). If the epoxide is ethylene oxide, then R^{e1} and R^{e2} will both be H. If the epoxide is propylene oxide, then R^{e1} will be H and R^{e2} will be methyl (or R^{e1} will be methyl and R^{e2} will be H, depending on how the epoxide is added into the polymer backbone). If the epoxide is butylene oxide, then R^{e1} will be H and R^{e2} will be ethyl (or vice versa). If the epoxide is styrene oxide, then R^{e1} may be hydrogen, and R^{e2} may be phenyl (or vice versa).

It will also be appreciated that if a mixture of epoxides are used, then each occurrence of R^{e1} and/or R^{e2} may not be the same, for example if a mixture of ethylene oxide and propylene oxide are used, R^{e1} may be independently hydrogen or methyl, and R^{e2} may be independently hydrogen or methyl.

Thus, R^{e1} and R^{e2} may be independently selected from hydrogen, alkyl or aryl, or R^{e1} and R^{e2} may together form a cyclohexyl ring, preferably R^{e1} and R^{e2} may be independently selected from hydrogen, methyl, ethyl or phenyl, or R^{e1} and R^{e2} may together form a cyclohexyl ring.

Z′ corresponds to R^{z}, except that a bond replaces the labile hydrogen atom. Therefore, the identity of each Z′ depends on the definition of R^{Z} in the starter compound. Thus, it will be appreciated that each Z′ may be —O—, —NR′—, —S—, —C(O)O—, —P(O)(OR′)O—, —PR′(O)(O—)₂ or —PR′(O)O— (wherein R′ may be H, or optionally substituted alkyl, heteroalkyl, aryl, heteroaryl, cycloalkyl or heterocycloalkyl, preferably R′ is H or optionally substituted alkyl), preferably Z′ may be —C(O)O—, —NR′— or —O—, more preferably each Z′ may be —O—, —C(O)O— or a combination thereof, more preferably each Z′ may be —O—.

Z also depends on the nature of the starter compound. Thus, Z may be selected from optionally substituted alkylene, alkenylene, alkynylene, heteroalkylene, heteroalkenylene, heteroalkynylene, cycloalkylene, cycloalkenylene, hererocycloalkylene, heterocycloalkenylene, arylene, heteroarylene, or Z may be a combination of any of these groups, for example Z may be an alkylarylene, heteroalkylarylene, heteroalkylheteroarylene or alkylheteroarylene group. Preferably Z is alkylene, heteroalkylene, arylene, or heteroarylene, e.g. alkylene or heteroalkylene. It will be appreciated that each of the above groups may be optionally substituted, e.g. by alkyl.

The variable a will also depend on the nature of the starter compound. The skilled person will appreciate that the value of a in formula (IV) will be the same as a in formula (III). Therefore, for formula (IV), a is an integer of at least 2, preferably a is in the range of between 2 and 8, preferably a is in the range of between 2 and 6.

The skilled person will also appreciate that the value of a will influence the shape of the polyol prepared by the method of the invention. For example, when a is 2, the polyol of formula (IV) may have the following structure:

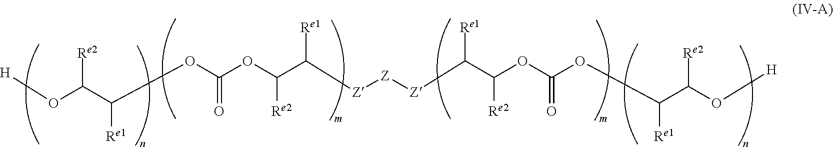

Where Z, Z′, m, n, R^{e1} and R^{e2} are as described above for formula (IV).

For example, when a is 3, the polyol of formula (IV) may have the following formula:

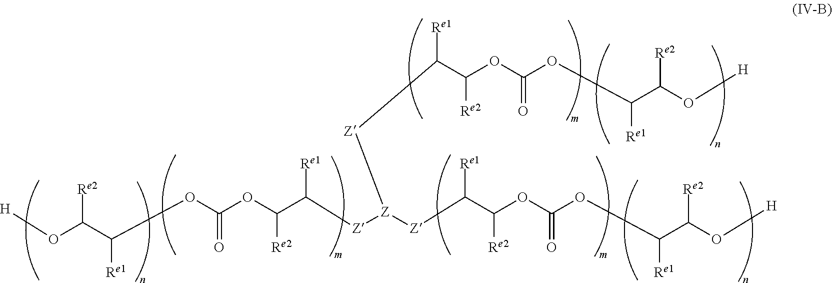

Where Z, Z′, m, n, R^{e1} and R^{e2} are as described above for formula (IV).

The skilled person will understand that each of the above features may be combined. For example, R^{e1} and R^{e2} may be independently selected from hydrogen, alkyl or aryl, or R^{e1} and R^{e2} may together form a cyclohexyl ring, each Z′ may be —O—, —C(O)O— or a combination thereof (preferably each Z′ may be —O—), and Z may be optionally substituted alkylene, heteroalkylene, arylene, or heteroarylene, e.g. alkylene or heteroalkylene, and a may be between 2 and 8.

The polyols produced by the method of the invention are preferably low molecular weight polyols. It will be appreciated that the nature of the epoxide used to prepare the polycarbonate ether polyol will have an impact on the resulting molecular weight of the product. Thus, the upper limit of n+m is used herein to define “low molecular weight” polymers of the invention.

The method of the invention can advantageously prepare a polycarbonate ether polyol having a narrow molecular weight distribution. In other words, the polycarbonate ether polyol may have a low polydispersity index (PDI). The PDI of a polymer is determined by dividing the weight average molecular weight (M_{w}) by the number average molecular weight (Mₙ) of a polymer, thereby indicating the distribution of the chain lengths in the polymer product. It will be appreciated that PDI becomes more important as the molecular weight of the polymer decreases, as the percent variation in the polymer chain lengths will be greater for a short chain polymer as compared to a long chain polymer, even if both polymers have the same PDI.

Preferably the polymers produced by the method of the invention have a PDI of from about 1 to less than about 2, preferably from about 1 to less than about 1.75, more preferably from about 1 to less than about 1.5, even more preferably from about 1 to less than about 1.3.

The Mₙ and M_{w}, and hence the PDI of the polymers produced by the method of the invention may be measured using Gel Permeation Chromatography (GPC). For example, the GPC may be measured using an Agilent 1260 Infinity GPC machine with two Agilent PLgel μ-m mixed-E columns in series. The samples may be measured at room temperature (293K) in THF with a flow rate of 1 mL/min against narrow polystyrene standards (e.g. polystyrene low easivials supplied by Agilent Technologies with a range of Mn from 405 to 49,450 g/mol). Optionally, the samples may be measured against poly(ethylene glycol) standards, such as polyethylene glycol easivials supplied by Agilent Technologies.

Preferably, the polymers produced by the method of the invention may have a molecular weight in the range of from about 500 Da to about 10,000 Da, preferably from about 700 Da to about 5,000 Da, preferably from about 800 Da to about 2,000 Da. The term “molecular weight” refers to number average molecular weight unless otherwise indicated.

The invention also provides a polymerisation system for the copolymerisation of carbon dioxide and an epoxide, comprising:
d. A catalyst of formula (I) as defined herein,
e. A DMC catalyst as defined herein, and
f. A starter compound as herein.

It will also be appreciated that the polyols prepared by the method of the invention may be used for further reactions, for example to prepare a polyurethane, for example by reacting a polyol composition comprising a polyol prepared by the method of the invention with a composition comprising a di- or polyisocyanate.

The skilled person will also appreciate that it may be possible to use other catalysts which are known to prepare polycarbonates via the reaction of an epoxide and carbon dioxide either as well as, or instead of, the catalysts of formula (I). For example, catalysts as defined in WO 2010/028362 are considered for this purpose.

### EXAMPLES

### Methods

### ¹H NMR Analysis

The assessment of polyether and polycarbonate content of the polyethercarbonate polyols has been reported in a number of different ways. In order to calculate the molar carbonate content and the CO₂ wt % in the polyethercarbonate polyols, the method described in US2014/0323670 was used herein. The method is as follows:

The samples were dissolved in deuterated chloroform and measured on a Bruker spectrometer. The relevant resonances in the ¹H-NMR spectra used for integration (in the case that 1,6-hexanediol is used as a starter) were:

TABLE A

| ¹H NMR | Protons from | No of |
|---|---|---|
| resonance (ppm) | repeating units | protons |
| A (1.08-1.18) | CH₃ of Polyether | 3 |
| B (1.18-1.25) | CH₃ of Polycarbonate end groups | 3 |
| C (1.26-1.38) | CH₃ of Polycarbonates | 3 |
| D (1.45-1.49) | CH₃ of cyclic carbonate | 3 |
| E (1.64-1.75) or (1.40-1.48) | CH₂ of hexanediol | 4 |
| F (2.95-2.99) | CH of propylene oxide | 1 |

The resonances A, C—F have been previously defined for polyethercarbonates containing a low proportion of carbonate linkages in the methods described in US2014/0323670. An extra resonance (B, 1.18-1.25 ppm) has been identified that is only present in significant quantities in polyethercarbonates with a high carbonate content. It has been assigned (by 2D NMR) as a terminal propylene CH₃ group between a carbonate unit and a hydroxyl end group. It is therefore added to the total carbonate units (C) as described in US2014/0323670.

Carbonate/ether ratio (m/n+m): molar ratio of carbonate and ether linkages:

$$\frac{m}{m + n} = Rc = \frac{B + C}{A + B + C} \qquad ( Equation 1 )$$

CO₂ wt % in polyol: amount of CO₂ incorporated into the total polyol:

$$CO 2 wt \% = \frac{( C + B ) \times 44}{( A \times 58 ) + ( ( B + C ) \times 102 ) + ( 0.75 \times ( E \times 118 ) )} \times 100 \qquad ( Equation 2 )$$

Wherein 44 is the mass of CO₂ within a carbonate unit, 58 is the mass of a polyether unit, 102 is the mass of a polycarbonate unit and 118 is the mass of the hexanediol starter (the factor 0.75 is added as the hexanediol resonance corresponds to 4 protons whilst all the other resonances correspond to 3). This is the total proportion of CO₂ that is present in the entire polyol. If other starters are used it is appreciated the relevant NMR signals, relative integrations and molecular weights will be used in the calculation.

Furthermore, resonance C can be broken down into two different resonances. From 1.26-1.32 ppm (C¹) corresponds to the propylene CH₃ in a polymer unit between a carbonate and an ether linkage (a polyethercarbonate, PEC linkage) whilst the resonance from 1.32-1.38 ppm (C²) comes from a propylene CH₃ in a polymer unit in between two carbonate linkages (a polycarbonate, PC linkage). The ratio of PEC, PC and PE linkages gives an indication of the structure of the polymer. A completely blocked structure will contain very few PEC linkages (only those at the block interfaces), whilst a more random structure will include a significant proportion of PEC linkages where both polyether and polycarbonate units are adjacent to each other in the polymer backbone. The ratio of these two units gives an indication of the structure.

Polyethercarbonate/polycarbonate linkage ratio:

$${R}_{PEC} = \frac{{C}^{1}}{{C}^{1} + {C}^{2}}$$

### Gel Permeation Chromatography

GPC measurements were carried out against narrow polydispersity poly(ethylene glycol) or polystyrene standards in THF using an Agilent 1260 Infinity machine equipped with Agilent PLgel Mixed-E columns.

### Mass Spectroscopy

All mass spectrometry measurements were performed using a MALDI micro MX micromass instrument.

### Example 1

Synthesis of DMC Catalyst According to U.S. Pat. No. 5,482,908 Example 1 (Catalyst 1)

The synthesis described in Example 1 of U.S. Pat. No. 5,482,908 was followed except the 4000 molecular weight polypropylene glycol diol was replaced with a 2000 molecular weight polypropylene glycol diol:

Potassium hexacyanocobaltate (8.0 g) was dissolved in deionised (DI) water (140 mL) in a beaker (solution 1). Zinc chloride (25 g) was dissolved in DI water (40 mL) in a second beaker (solution 2). A third beaker containing solution 3 was prepared: a mixture of DI water (200 mL), tert-butyl alcohol (2 mL) and polyol (2 g of a 2000 mol. wt. polypropylene glycol diol). Solutions 1 and 2 were mixed together using a mechanical stirrer. Immediately a 50/50 (by volume) mixture of tert-butyl alcohol and DI water (200 mL total) was added to the zinc hexacyanocobaltate mixture, and the product was stirred vigorously for 10 min. Solution 3 (polyol/water/tert-butyl alcohol mixture) was added to the aqueous slurry of zinc hexacyanocobaltate and the product stirred magnetically for 3 min. The mixture was filtered under pressure to isolate the solids. The solid cake was reslurried in tert-butyl alcohol (140 mL), DI water (60 mL), and an additional 2 g of the 2000 mol. wt. polypropylene glycol diol. Then mixture was stirred vigorously for 10 min. and filtered. The solid cake was reslurried in tert-butyl alcohol (200 mL) and an additional 1 g of 2000 mol. wt. polypropylene glycol diol and stirred vigorously for 10 minutes, then filtered. The resulting solid catalyst was dried under vacuum (<1 mbar) at 50° C. to constant weight. The yield of dry, powdery catalyst was 8.5 g.

### Example 2

### Synthesis of DMC Catalyst According to WO2012/156431 Example 1 (Catalyst 2)

The synthesis described in Example 1 was followed except that the polypropylene glycol of MWn 400 was replaced with a polypropylene glycol of MWn 425.

### 1^{st} Step

Potassium hexacyanocobaltate (7.5 g) was dissolved in DI water (100 mL) in a beaker (solution A). Zinc chloride (75 g) and tert-butyl alcohol (50 mL) were dissolved in DI water (275 mL) in a second beaker (solution B). Solution B was heated at a temperature of 50° C. Subsequently, solution A was slowly added for 30 minutes to solution B whilst stirring at 400 rpm. The aqueous zinc chloride and tert-butyl alcohol solution and the cobalt salt solution were combined using a stirrer to intimately and efficiently mixed both aqueous solutions. The mixture was held post-reacting for 30 minutes at the same temperature to form a slurry of zinc hexacyanocobaltate. A third solution (solution C) was prepared by dissolving a 425 mol. wt. diol (8 g, polypropylene glycol) in DI water (50 mL) and tert-butyl alcohol (2 mL). Solution C (PPG/water/tert-butyl alcohol mixture) was added to the aqueous slurry zinc hexacyanocobaltate for 5 minutes and the product was stirred for an additional 10 minutes. The mixture was filtered under pressure to isolate the solid.

### 2^{nd} Step

The solid cake was reslurried in DI water (150 mL) for 30 minutes at a temperature of 50° C. and subsequently, additional 425 mol. wt. polypropylene glycol (2 g) was added. The mixture was stirred for 10 minutes then filtered.

### 3^{rd} Step

The solid cake obtained after the second step was reslurried in tert-butyl alcohol (185 mL) for 30 minutes at a temperature of 50° C. and subsequently, additional 425 mol. wt. diol polypropylene glycol (1 g) was added. The mixture was homogenised by stirring for 5 minutes and filtered.

The resulting solid catalyst was dried under vacuum at 100° C. and <1 mbar to constant weight. Yield of powdered catalyst 8 g.

### Example 3: Synthesis of DMC Catalyst 3

The DMC catalyst used in this example was prepared according to the method reported in Journal of Polymer Science; Part A: Polymer Chemistry, 2002, 40, 1142. In brief, 1.0 g of K₃Co(CN)₆ was dissolved in a mixture solvent of 13 g distilled water and 2 g tert-butyl alcohol. 6 g of ZnCl₂ was dissolved in a mixture solvent of 13 g water and 4 g tert-butyl alcohol, and then this mixture was added slowly to the K₃Co(CN)₆ solution over a period of 20 minutes, whilst stirring. The mixture was then stirred for a further 40 minutes and then centrifugal separation was performed to yield a white precipitate. The precipitate was dispersed in a mixture solvent of 16 g water and 16 g tert-butyl alcohol, and stirred for 20 minutes, and then the precipitate was separated by centrifuge. This washing procedure was repeated 3 times. The white precipitate was then dispersed in 50 g tert-butyl alcohol, and then stirred for 20 minutes, followed by centrifugal separation to obtain a white precipitate. The washing with tert-butyl alcohol was then repeated once more. The solvent was then removed under reduced pressure at 60° C. for 8 hours. The resultant compound is understood to have the formula Zn₃[Co(CN)₆]₂.hZnCl₂. 0.5H₂O.2[(CH₃)₃COH].

### Example 4: Synthesis of Catalyst 4

Catalyst 4 was prepared as described in PCT/GB2016/052676 (WO2017/037441).

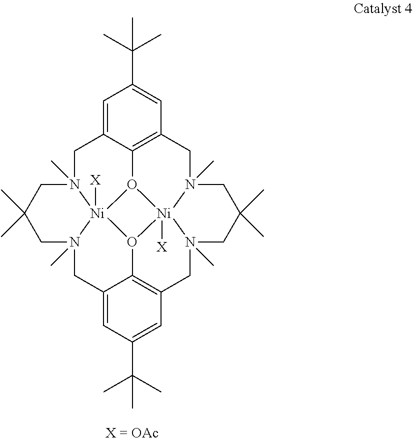

### Example 5: Copolymerisation of Propylene Oxide and Carbon Dioxide Using Two Catalysts

5 mg of the DMC catalyst (1, 2 or 3) as referred to above was taken into a 100 mL oven dried reactor along with 1,6-hexanediol (0.51 g). The catalyst and starter were dried at 110-120° C. under vacuum for 1-2 hours. The reactor was cooled down to room temperature and a propylene oxide (PO; 15 mL) solution of catalyst 4 (51.5 mg) was injected into the vessel via a syringe under continuous flow of CO₂ gas. The vessel was heated to the desired temperature and filled to the desired CO₂ pressure. The reaction was continued for 16 hours. Once the reaction was finished, the reactor was cooled to below 10° C. and the pressure was released. NMR and GPC were measured immediately. The reactions run at 75° C. contained no unreacted PO. Reactions at 65° C. contained between 3-14% unreacted PO.

TABLE 1

| | DMC | Temp | Pressure | % Carbonate | CO₂ | | |
|---|---|---|---|---|---|---|---|
| Run | Catalyst | (° C.) | (bar) | linkages | wt % | Mn | PDI |
| 1 | 1 | 60 | 10 | 60 | 29.0 | 2400 | 2.38 |
| 2 | 2 | 60 | 10 | 53 | 27.1 | 1400 | 1.97 |
| 3 | 1 | 75 | 10 | 36 | 20.8 | 2200 | 1.71 |
| 4 | 2 | 75 | 10 | 40 | 22.7 | 2300 | 1.98 |

Runs 1-4 in Table 1 demonstrate the ability of the dual catalyst system to produce high carbonate content polyethercarbonate polyols using a DMC catalyst that contains two coordinating agents wherein one of the coordinating agents is a polymer. The high carbonate content polyols were produced under 10 bar pressure which is a fraction of the pressure that would be necessary to produce this much carbonate content using the DMC catalysts alone. Furthermore, the polyethercarbonate polyols do not require a starter with a high molecular weight (e.g. >500 Mn).

TABLE 2

| | | | % | | | | | |
|---|---|---|---|---|---|---|---|---|
| | | | Carbo- | | Selec- | PO | | |
| | DMC | P | nate | CO₂ | tivity | Conv. | | |
| Run | Catalyst | (bar) | linkages | wt % | % | % | Mn | PDI |
| 5 | 2 (PPG/ | 5 | 44 | 23.6 | 69 | 89 | 1900 | 2.26 |
| | TBA) | | | | | | | |
| 6 | 3 | 5 | 47 | 24.6 | 62 | 84 | 1500 | 1.73 |
| | (TBA) | | | | | | | |

Runs 5 and 6 in Table 2 were carried out as per runs 1-4, except they were run at 60° C. and only 5 bar pressure of CO₂. Run 5 was carried out using DMC catalyst 2 that contained two complexing agents, tert-butyl alcohol (TBA) and PPG diol. Run 6 was carried out using DMC catalyst 3 that only contained TBA and not the first polymer complexing agent. It can be clearly seen that both the selectivity for polymer and the PO conversion were significantly improved by using DMC catalyst 2 containing the PPG diol.

### Example 5

### Synthesis of DMC Catalyst 5

The DMC catalyst used in this example was prepared according to the method reported in European Polymer Journal, 2017, 88, 280-291, catalyst E. K₃[Co(CN)₆]₂(0.77 g) was dissolved in 80 ml of mili-Q water and ZnCl₂ (1.77 g) in 210 ml of miliQ water and 50 ml of tBuOH. Both solutions were mixed and vigorously stirred 15 min at 50° C. After 13 min PEG 1000 was added to the mixed solution, the white suspension was centrifugated 6 min at 5000 rpm. The isolated slurry was resuspended with strong stirring during 20 min in 100 ml of a t-BuOH: H₂O (50:50) solution and it was centrifugated as previous. The solid was resuspended in 100 ml of 100% t-BuOH and stirred for 30 min, filtered (omnipore PTFE membrane filter, 0.1 micrometer, Merck Milipore) and dried under vacuum at 50° C. during 30 h.

### Example 6

### Example 6: Copolymerisation of Propylene Oxide and Carbon Dioxide Using Two Catalysts

5 mg of the DMC catalyst (2, 3 or 5) as referred to above was taken into a 100 mL oven dried reactor along with 1,12-dodecanediol (1.3 g). The catalyst and starter were dried at 110-120° C. under vacuum for 1-2 hours. The reactor was cooled down to room temperature and a propylene oxide (PO; 15 mL) solution of catalyst 4 (51.5 mg) was injected into the vessel via a syringe under continuous flow of CO₂ gas. The vessel was heated to 75° C. and filled to 5 bar CO₂ pressure. The reaction was continued for 16 hours. Once the reaction was finished, the reactor was cooled to below 10° C. and the pressure was released. NMR and GPC were measured immediately.

TABLE 3

| | | % carbonate | CO₂ | PO Conv. | | |
|---|---|---|---|---|---|---|
| Run | DMC catalyst | linkages | (wt %) | % | Mn | PDI |
| 6 | 3 (TBA) | 17 | 10.8 | 93 | 1900 | 1.30 |
| 7 | 5 (PEG/TBA) | 40 | 21.4 | 100 | 2400 | 1.39 |
| 8 | 2 (PPG/TBA) | 31 | 16.7 | 98 | 1900 | 1.46 |

The catalysts were tested with dodecanediol as a starter. Run 6 demonstrates the performance of catalyst 3, made with only tert-butyl alcohol as a complexing agent and not the first polymer complexing agent. In comparison, runs 7 & 8 use catalysts 5 and 2 which contain a polymer complexing agent, PEG-1000 and PPG-425 respectively. These catalysts were demonstrated to produce polyols with substantially more carbonate linkages and with higher PO conversion, further demonstrating the benefit of having these two complexing agents present in the DMC catalyst. Beneficially, runs 6 & 7 demonstrate that the combination of catalyst 4 and DMC catalysts with two complexing agents can be used to incorporate high amounts of CO₂ even under low pressures such as 5 bar.

### Example 7

### Example 7: Copolymerisation of Propylene Oxide and Carbon Dioxide Using Two Catalysts

5 mg of the DMC catalyst 5 as referred to above was taken into a 100 mL oven dried reactor along with 1,6-hexanediol (1.02 g). The catalyst and starter were dried at 110-120° C. under vacuum for 1-2 hours. The reactor was cooled down to room temperature and a propylene oxide (PO; 15 mL) solution of catalyst 4 (51.5 mg) was injected into the vessel via a syringe under continuous flow of CO₂ gas. The vessel was heated to 60 C and filled to 10 bar CO₂ pressure. The reaction was continued for 16 hours. Once the reaction was finished, the reactor was cooled to below 10° C. and the pressure was released. NMR and GPC were measured immediately. The reaction produced a polymer with 68% carbonate linkages (31 wt % CO₂), a selectivity of 97% and a molecular weight of 1550, with a PDI of 1.53.

### Example 8

5 mg of the DMC catalyst 5 as referred to above was taken into a 100 mL oven dried reactor along with propoxylate glycerol (Mn 260, 0.78 mL). The catalyst and starter were dried at 110-120° C. under vacuum for 1-2 hours. The reactor was cooled down to room temperature and a propylene oxide (PO; 15 mL) solution of catalyst 4 (45 mg) was injected into the vessel via a syringe under continuous flow of CO₂ gas. The vessel was heated to 70° C. and filled to 5 bar CO₂ pressure. The reaction was continued for 16 hours. Once the reaction was finished, the reactor was cooled to below 10° C. and the pressure was released. NMR and GPC were measured immediately. The reaction produced a polymer with 40% carbonate linkages (21 wt % CO₂), a selectivity of 94% and a molecular weight of 2800, with a PDI of 1.25.

1. A method for preparing a polycarbonate ether polyol, the method comprising reacting carbon dioxide and an epoxide in the presence of a double metal cyanide (DMC) catalyst, a catalyst of formula (I), and a starter compound,
wherein the catalyst of formula (I) has the following structure: 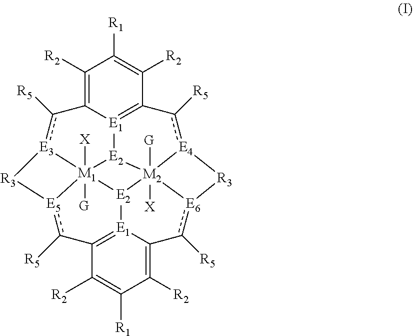
wherein M₁ and M₂ are independently selected from Zn(II), Cr(II), Co(II), Cu(II), Mn(II), Mg(II), Ni(II), Fe(II), Ti(II), V(II), Cr(III)-X, Co(III)-X, Mn(III)-X, Ni(III)-X, Fe(III)-X, Ca(II), Ge(III), AI(II)-X, Ti(II)-X, V(III)-X, Ge(IV)-(X)₂ or Ti(IV)-(X)₂;
R₁ and R₂ are independently selected from hydrogen, halide, a nitro group, a nitrile group, an imine, an amine, an ether group, a silyl group, a silyl ether group, a sulfoxide group, a sulfonyl group, a sulfinate group or an acetylide group or an optionally substituted alkyl, alkenyl, alkynyl, haloalkyl, aryl, heteroaryl, alkoxy, aryloxy, alkylthio, arylthio, alicyclic or heteroalicyclic group;
R₃ is independently selected from optionally substituted alkylene, alkenylene, alkynylene, heteroalkylene, heteroalkenylene, heteroalkynylene, arylene, heteroarylene or cycloalkylene, wherein alkylene, alkenylene, alkynylene, heteroalkylene, heteroalkenylene and heteroalkynylene, may optionally be interrupted by aryl, heteroaryl, alicyclic or heteroalicyclic;
R₅ is independently selected from H, or optionally substituted aliphatic, heteroaliphatic, alicyclic, heteroalicyclic, aryl, heteroaryl, alkylheteroaryl or alkylaryl;
E₁ is C, E₂ is O, S or NH or E₁ is N and E₂ is O;
E₃, E₄, E₅ and E₆ are selected from N, NR₄, O and S, wherein when E₃, E₄, E₅ or E₆ are N, [symbol] is [symbol] , and wherein when E₃, E₄, E₅ or E₆ are NR₄, O or S, [symbol] is [symbol] ;
R₄ is independently selected from H, or optionally substituted aliphatic, heteroaliphatic, alicyclic, heteroalicyclic, aryl, heteroaryl, alkylheteroaryl, -alkylC(O)OR₁₉ or -alkylC≡N or alkylaryl;
X is independently selected from OC(O)Rₓ, OSO₂Rₓ, OSORₓ, OSO(Rₓ)₂, S(O)Rₓ, ORₓ, phosphinate, halide, nitrate, hydroxyl, carbonate, amino, amido or optionally substituted aliphatic, heteroaliphatic, alicyclic, heteroalicyclic, aryl or heteroaryl, wherein each X may be the same or different and wherein X may form a bridge between M₁ and M₂;
Rₓ is independently hydrogen, or optionally substituted aliphatic, haloaliphatic, heteroaliphatic, alicyclic, heteroalicyclic, aryl, alkylaryl or heteroaryl; and
G is absent or independently selected from a neutral or anionic donor ligand which is a Lewis base; and
and wherein the starter is a compound having the following structure:
ZR^{Z})ₐ (III)
Z is selected from optionally substituted alkylene, alkenylene, alkynylene, heteroalkylene, heteroalkenylene, heteroalkynylene, cycloalkylene, cycloalkenylene, hererocycloalkylene, heterocycloalkenylene, arylene, heteroarylene, or Z may be a combination of any of these groups, such as an alkylarylene, heteroalkylarylene, heteroalkylheteroarylene or alkylheteroarylene group;
a is an integer which is at least 2; and
each R^{Z} may be —OH, —NHR′, —SH, —C(O)OH, PR′(O)(OH)₂, —P(O)(OR′)(OH),—PR′(O)OH, or a combination thereof,
and wherein the DMC catalyst contains at least two metal centres, cyanide ligands, a first complexing agent and a second complexing agent, wherein the first complexing agent is a polymer.

2. The method of claim 1 wherein the DMC catalyst contains from 5% to 80% by weight of the first complexing agent.

3. The method of claim 1, wherein the polymer is selected from a polyether, a polycarbonate ether, and a polycarbonate.

4. The method of claim 3, wherein the polymer is a polyether having a molecular weight between 1,000 Daltons and 10,000 Daltons.

5. The method of claim 1, wherein the second complexing agent is selected from the group consisting of ethers, ketones, esters, amides, alcohols, and ureas.

6. The method of claim 5, wherein the second complexing agent is an alcohol.

7. The method of claim 6, wherein the alcohol is selected from methanol, ethanol, isopropyl alcohol, n-butyl alcohol, isobutyl alcohol, sec-butyl alcohol, (m)ethoxy ethylene glycol, -buten-1-ol, 2-methyl-3-buten-2-ol, 2-methyl-3-butyn-2-ol, 3-methyl-1-pentyn-3-ol, propylene glycol and tert-butyl alcohol.

8. The method of claim 5, wherein the second complexing agent is an ether,

9. The method of claim 8, wherein the ether is selected from dimethoxyethane, ethylene glycol monomethyl ether, diglyme, and triglyme.

10. The method of claim 1, wherein the second complexing agent is tert-butyl alcohol, and the polymer is a polyether.

11. The method of claim 1, wherein the DMC catalyst contains a further complexing agent.

12. The method of claim 1, wherein the first and second metal centres of the DMC catalyst are represented by M′ and M″ respectively. wherein
M′ is selected from Zn(II), Ru(II), Ru(III), Fe(II), Ni(II), Mn(II), Co(II), Sn(II), Pb(II), Fe(III), Mo(IV), Mo(VI), Al(III), V(V), V(VI), Sr(II), W(IV), W(VI), Cu(II), and Cr(III), and
M″ is selected from Fe(II), Fe(III), Co(II), Co(III), Cr(II), Cr(III), Mn(II), Mn(III), Ir(III), Ni(II), Rh(III), Ru(II), V(IV), and V(V),

13. The method of claim 12, wherein M′ is selected from Zn(II), Fe(II), Co(II) and Ni(II).

14. The method of claim 12, wherein M″ is selected from Co(II), Co(III), Fe(II), Fe(III), Cr(III), Ir(III) and Ni(II).

15. The method of claim 1 wherein the reaction is carried out at a pressure of between 1 bar and 60 bar carbon dioxide.

16. The method of claim 1, wherein M₁ and/or M₂ is selected from Mg(II), Zn(II) or Ni(II).

17. The method of claim 1, wherein X is independently selected from OC(O)R^{x}, OSO₂R^{x}, OS(O)R^{x}, OSO(R^{x})₂, S(O)R^{x}, OR^{x}, halide, nitrate, hydroxyl, carbonate, amino, nitro, amido, alkyl, heteroalkyl, aryl or heteroaryl, and/or R^{x} may be optionally substituted alkyl, alkenyl, alkynyl, heteroalkyl, aryl, heteroaryl, cycloalkyl, or alkylaryl.

18. The method of claim 1, wherein the catalyst of formula (I) has a symmetric macrocyclic ligand.

19. The method of claim 1, wherein the catalyst of formula (I) has an asymmetric macrocyclic ligand.

20. The method of claim 19, wherein E₃, E₄, E₅ and E₆ are NR₄, wherein at least one occurrence of E₃, E₄, E₅ and E₆ is different to the remaining occurrence(s) of E₃, E₄, E₆.

21. The method of, wherein E₃, E₄, E₅ and E₆ are NR₄, wherein each R₄ is independently H or optionally substituted aliphatic.

22. The method of claim 1, wherein E₁ is C, and E₂ is O.

23. The method of claim 1, wherein R₅ is H and wherein R₂ is H.

24. The method of claim 1, wherein R₃ is an optionally substituted alkylene group or an optionally substituted C₂ or C₃ alkylene group.

25. The method of claim 1, wherein R₁ is independently selected from hydrogen, halide, amino, nitro, sulfoxide, sulfonyl, sulfinate, and an optionally substituted alkyl, alkenyl, aryl, heteroaryl, silyl, silyl ether, alkoxy, aryloxy or alkylthio.

26. The method according to claim 1, wherein the catalyst is of the formula:

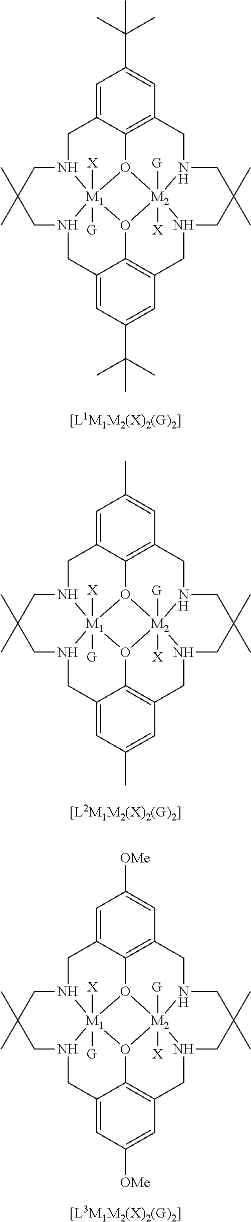

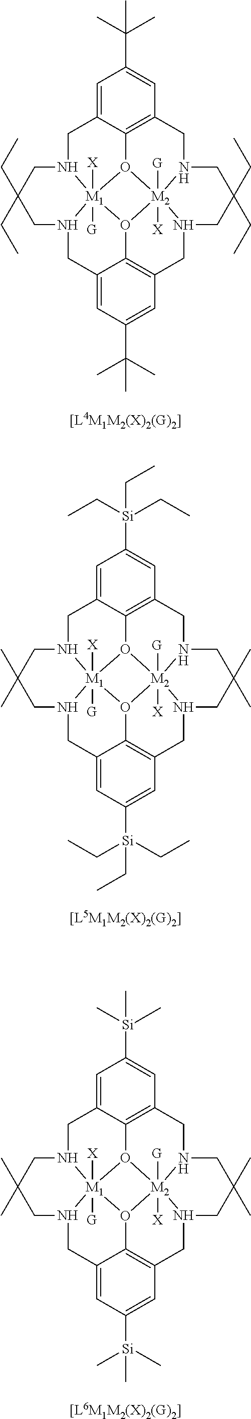

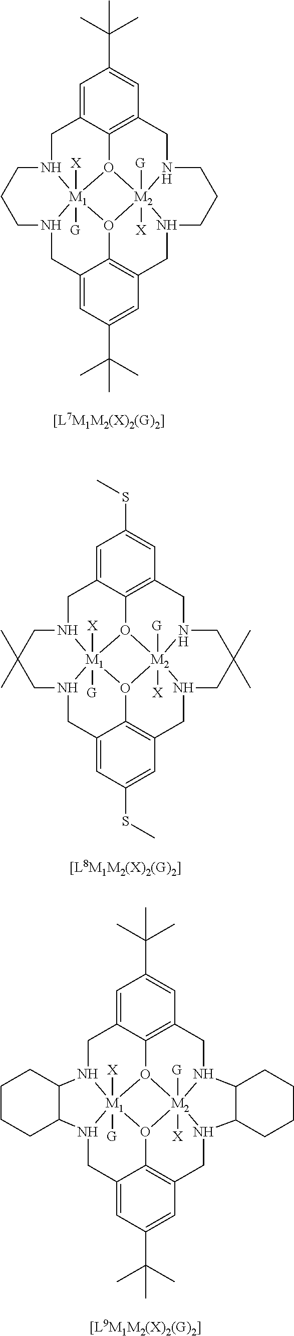

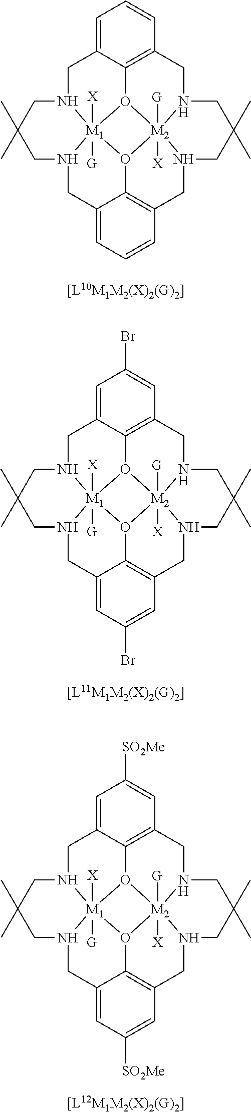

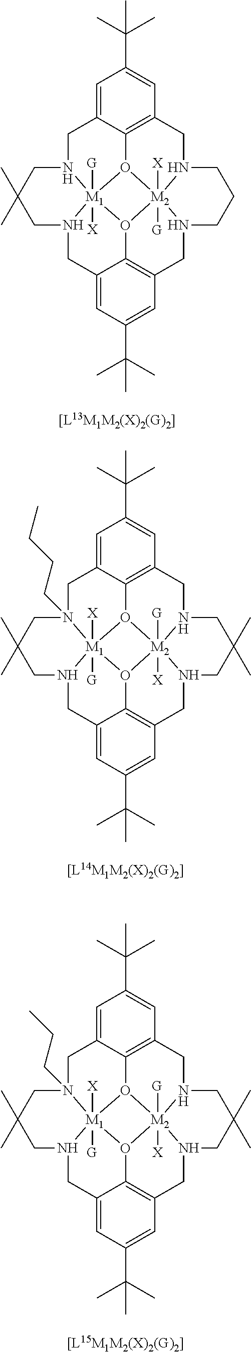

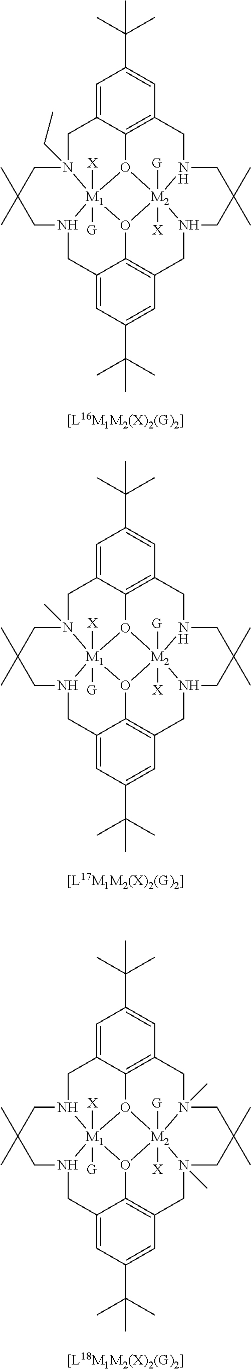

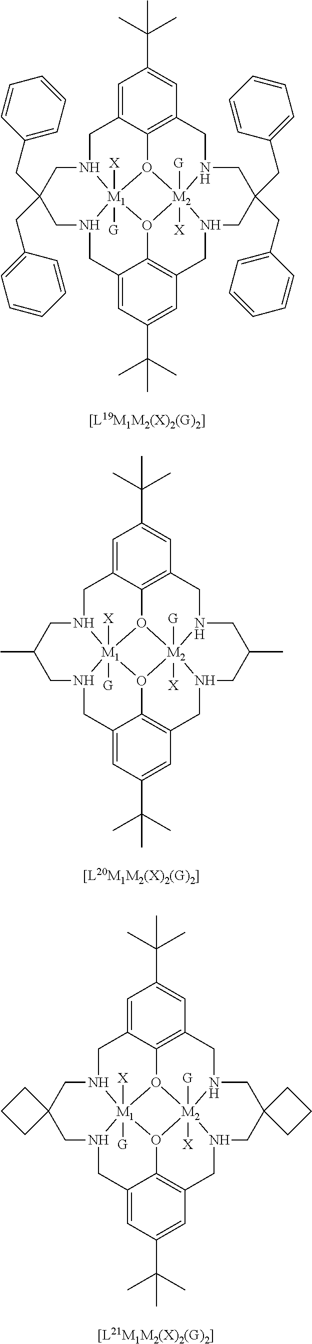

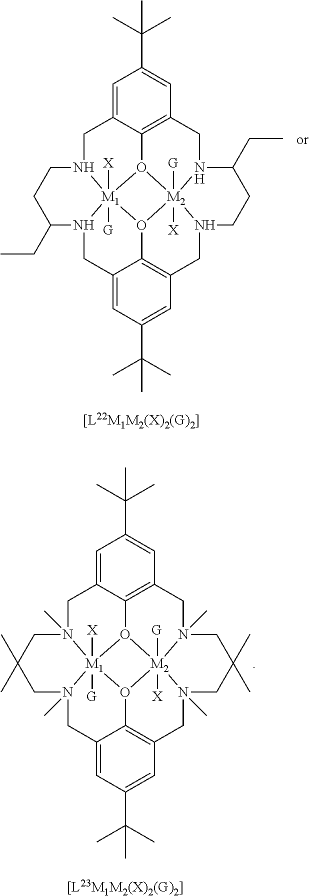

27. The method of claim 1, wherein the reaction is carried out at a temperature in the range of from 50° C. to 110° C.

28. The method of claim 1, wherein each occurrence of R^{Z} may be —OH.

29. The method of claim 1, wherein a is an integer in the range of between 2 and 8.

30. The method of claim 1, wherein the starter compound is from diols such as 1,2-ethanediol (ethylene glycol), 1-2-propanediol, 1,3-propanediol (propylene glycol), 1,2-butanediol, 1-3-butanediol, 1,4-butanediol, 1,5-pentanediol, 1,6-hexanediol, 1,8-octanediol, 1,10-decanediol, 1,4-cyclohexanediol, 1,2-diphenol, 1,3-diphenol, 1,4-diphenol, neopentyl glycol, catechol, cyclohexenediol, 1,4-cyclohexanedimethanol, dipropylene glycol, diethylene glycol, tripropylene glycol, triethylene glycol, tetraethylene glycol, polypropylene glycols (PPGs) or polyethylene glycols (PEGs) having an Mn of up to 1500 g/mol, such as PPG 425, PPG 725, PPG 1000 and the like, triols such as glycerol, benzenetriol, 1,2,4-butanetriol, 1,2,6-hexanetriol, tris(methylalcohol)propane, tris(methylalcohol)ethane, tris(methylalcohol)nitropropane, trimethylol propane, polypropylene oxide triols and polyester triols, tetraols such as calix[4]arene, 2,2-bis(methylalcohol)-1,3-propanediol, erythritol, pentaerythritol or polyalkylene glycols (PEGs or PPGs) having 4—OH groups, polyols, such as sorbitol or polyalkylene glycols (PEGs or PPGs) having 5 or more —OH groups, diacids such as oxalic acid, malonic acid, succinic acid, glutaric acid, adipic acid, pimelic acid, suberic acid, azelaic acid, sebacic acid, undecanedioic acid, dodecanedioic acid or other compounds having mixed functional groups such as lactic acid, glycolic acid, 3-hydroxypropanoic acid, 4-hydroxybutanoic acid, 5-hydroxypentanoic acid.

31. The method of claim 1, wherein the starter compound is a diol such as 1,2-ethanediol (ethylene glycol), 1-2-propanediol, 1,3-propanediol (propylene glycol), 1,2-butanediol, 1-3-butanediol, 1,4-butanediol, 1,5-pentanediol, 1,6-hexanediol, 1,8-octanediol, 1,10-decanediol, 1,12-dodecanediol, 1,4-cyclohexanediol, 1,2-diphenol, 1,3-diphenol, 1,4-diphenol, neopentyl glycol, catechol, cyclohexenediol, 1,4-cyclohexanedimethanol, poly(caprolactone) diol, dipropylene glycol, diethylene glycol, tripropylene glycol, triethylene glycol, tetraethylene glycol, polypropylene glycols (PPGs) or polyethylene glycols (PEGs) having an Mn of up to 1500 g/mol, such as PPG 425, PPG 725, PPG 1000 and the like.

32. The method of claim 1, wherein the DMC catalyst is prepared by treating a solution of a metal salt with a solution of a metal cyanide salt in the presence of the first and the second complexing agent, X′ is an anion selected from halide, hydroxide, sulphate, carbonate, cyanide, oxalate, thiocyanate, isocyanate, isothiocyanate, carboxylate and nitrate,
p is an integer of 1 or more, and the charge on the anion multiplied by p satisfies the valency of M′;
the metal cyanide salt is of the formula (Y)_{q}M″(CN)_{b}(A)_{c},
M′ and M″ are as defined in claims 12 to 14,
Y is a proton or an alkali metal ion or an alkaline earth metal ion (such as K⁺),
A is an anion selected from halide, hydroxide, oxide, sulphate, cyanide oxalate, thiocyanate, isocyanate, isothiocyanate, carboxylate and nitrate;
q and b are integers of 1 or more;
c may be 0 or an integer of 1 or more;
the sum of the charges on the anions Y, CN and A multiplied by q, b and c respectively (e.g. Y×q+CN×b+A×c) satisfies the valency of M″;
and the first and second complexing agents.

33. The method of claim 1, wherein the DMC catalyst comprises the formula:
M′_{d}[M″ₑ(CN)_{f}]_{g}
wherein d, e, f and g are integers, and are chosen to such that the DMC catalyst has electroneutrality.

34. The method of claim 32 wherein M′ is selected from Zn(II), Fe(II), Co(II) and Ni(II) and/or M″ is selected from Co(II), Co(III), Fe(II), Fe(III), Cr(III), Ir(III) and Ni(II).

35. The method of claim 1, wherein the DMC catalyst additionally comprises water, an acid and/or a metal salt.

36. The method of claim 1, wherein the DMC catalyst comprises the formula:
M′_{d}[M″ₑ(CN)_{f}]_{g}.hM′″X″ᵢ.jR^{c}.kH₂O.IHᵣX′″.Pol
wherein d, e, f and g are integers, and are chosen to such that the DMC catalyst has electroneutrality,
M′″ can be M′ and/or M″;
X″ is an anion selected from halide, hydroxide, oxide, sulphate, carbonate, cyanide, oxalate, thiocyanate, isocyanate, isothiocyanate, carboxylate and nitrate;
i is an integer of 1 or more, and the charge on the anion X″ multiplied by i satisfies the valency of M′″;
X′″ is an anion selected from halide, sulfate, phosphate, borate, chlorate, carbonate, cyanide, oxalate, thiocyanate, isocyanate, isothiocyanate, carboxylate and nitrate;
r is an integer that corresponds to the charge on the counterion X′″
h is from 0 to 4;
j is an integer between 0.1 and 6;
k is from 0 to 20;
l is from 0 to 5;
R^{c} is the second complexing agent; and
Pol is the first complexing agent which is a polymer.

37. The method of claim 1, wherein, a polymerisation system for the copolymerisation of carbon dioxide and an epoxide, comprises:
a. the catalyst of formula (I),
b. the DMC catalyst, and
c. the starter compound.

38. The method of claim 1, wherein, a polyol is prepared.

39. The method of claim 35, wherein, a polyurethane or other higher polymer is prepared from a polycarbonate ether polyol.
